(19) United States
(12) Patent Application Publication
(10) Pub. No.: US 2019/0217337 A1
(43) Pub. Date: Jul. 18, 2019

(54) COATING COMPOSITIONS AND PROCESSES FOR MAKING THE SAME

(71) Applicant: SHAWCOR LTD., Toronto (CA)

(72) Inventors: Nitin Gujare, Mississauga (CA); Jiri Holub, Toronto (CA); Jun Tabiendo, Toronto (CA); Alfredo Andrenacci, Toronto (CA)

(73) Assignee: SHAWCOR LTD., Toronto (CA)

(21) Appl. No.: 16/302,382

(22) PCT Filed: May 12, 2017
(86) PCT No.: PCT/CA2017/050575

§ 371 Date: Nov. 16, 2018

Related U.S. Application Data
(60) Provisional application No. 62/337,562, filed on May 17, 2016.

(51) Int. Cl. B05D 7/14; B05D 7/00; B05D 1/26; B05D 3/02; C08L 23/06; C08L 63/00; C09J 151/06; B05D 1/02

(52) U.S. Cl. CPC B05D 7/148; C08K 3/34; B05D 7/544; B05D 1/265; B05D 3/0218; C08L 23/06; C08L 63/00; C09J 151/06; B05D 1/02; B05D 2401/32; B05D 2254/02; B05D 2504/00; B05D 2451/00; B05D 2507/00; C08L 2312/06; B05D 7/146

(57) ABSTRACT

The present invention relates to coating compositions, processes for making them, and methods of application of the coating compositions. Further, the present invention relates to a process and apparatus for coating a metal substrate, for example an elongated metal tubular substrate such as a pipe. Most particularly, the coating can be used as an anti-corrosion coating on a pipe for use in oil, gas and water pipeline applications.

### FIELD

The present invention relates to coating compositions, processes for making them, and methods of application of the coating compositions. Further, the present invention relates to a process and apparatus for coating a metal substrate, for example an elongated metal tubular substrate such as a pipe. Most particularly, the coating can be used as an anti-corrosion coating on a pipe for use in oil, gas and water pipeline applications.

### BACKGROUND

Fusion bonded epoxy (FBE) is often used as an anti-corrosion coating on pipe. FBE consists of a solid epoxy which is applied to a clean, hot pipe, typically using a powder coating process. The FBE powder melts when it contacts the hot pipe, forming a generally uniform film surface. FBE coatings provide excellent anti-corrosion properties, but have poor low temperature bend-ability and impact resistance when used as a single layer coating, and are thus prone to impact damage during transportation. Single layer FBE coatings are also prone to absorbing water when exposed to elevated temperatures (above 50° C.) in hot and wet environments; this in turn can cause blistering when induction heating is used in preparing a field joint. FBE can be applied as a dual layer coating to provide tough physical properties and minimize damage during handling, transportation and installation. However, dual layer FBE coatings are not price competitive.

U.S. Pat. No. 5,178,902, assigned to the present applicant, describes a high performance composite coating (HPCC) for pipe, comprising three layers of material, namely an FBE coating, which itself is coated with an adhesive layer, followed by a polyolefin top coat. The polyolefin top coat is a non-crosslinked polyolefin, and provides very good impact resistance. It also prevents moisture permeation and is resistant to elevated ambient temperatures (for example, above 50° C. but below 80° C.) in hot and wet environments. The primary purpose of the intermediate, adhesive layer, is to bond the polyolefin layer to the FBE coating. Typically, without the use of such an adhesive layer, there can be some difficulty in obtaining a strong and durable bond between the FBE coating and the polyolefin top coat. In addition, with this approach, the cost of such a system can be significantly higher than the main competitive system, which is an FBE only single layer coating.

Other prior art approaches include “compatibilizing” the top coat polyolefin layer to the FBE coating, using a blend of epoxy and polyolefin in the top coat layer. Such prior art approaches can be found in U.S. Pat. No. 5,198,497 (Mathur), U.S. Pat. No. 5,709,948 (Perez et al) and WO 2007/022031 published Feb. 22, 2007 (Perez et al). Relatively high temperatures are required during the blending of the composition in order to polymerize the epoxy resin component. The fact that polymerization occurs during the mixing of the two components, i.e. in the presence of the polyolefin, creates a so-called “interpenetrating polymer network”. These high temperatures require the use of higher polyolefins, such as polypropylene. Also by Perez et al., U.S. Pat. Nos. 8,231,943, 7,790,288 and patent publication 2007/0034316, describe interpenetrating polymer networks comprising a polyolefin (in all cases, polypropylene) and an epoxy. However, though these interpenetrating polymer networks—based compositions appear to work well, they require considerable skill, expense, and high temperatures to make, due to the requirement for an interpenetrating polymer network. Notably, to polymerize at least one of the polyolefin and epoxy in the presence of the other to form an interpenetrating network requires considerably higher temperature and complex equipment.

Other prior art coatings include the polyolefin and epoxy resin mixtures proposed in U.S. Pat. No. 4,345,004 (Miyake et al). However, blends exemplified in the Miyake et al patent are not as stable as may be considered desirable as the epoxy component tends to separate as a phase separate from the polyolefin component, or the blends require solvents for application. The latter present problems of porosity of the coating as a result of off-gassing of solvent residue.

Recently, it has been found that a fully or partially cross-linked top coat polyolefin layer is desirable. Partially or fully cross-linked polyolefins provide much improved temperature resistance, are much more impact resistant and generally more durable than their non-cross linked equivalents. However, inherent in their nature is that melting a partially or fully cross-linked polyolefin requires a much higher melt temperature, which can make it impossible or impractical for extruding directly onto a pipe, or, worse, onto an FBE coating that is already applied to the pipe, since the temperature at which the partially or fully cross-linked polyolefin can be extruded will often exceed the melt temperature of the FBE layer.

Processes for applying a polyolefin layer, and cross-linking it in situ, are described in PCT/CA2013/050765 and PCT/CA2015/050337, incorporated herein by reference. Specific compositions and batch-based formulations useful as polyolefin compositions for coating pipe utilizing the processes therein described are also taught and described.

It would be desirable to provide a coating for a pipe that overcomes one or more of the problems of the prior art. It would also be desirable to provide a method for coating a pipe that overcomes such problems and/or is more cost effective than the prior art methods.

### SUMMARY OF THE INVENTION

According to one aspect of the invention is provided a method for coating an elongate metallic tubular article having an exterior surface and an interior surface, comprising, in-line: (a) optionally applying a fusion bonded epoxy coating to the surface; (b) applying a reactive polyolefin blend to said exterior surface or fusion bonded epoxy coating to form a polyolefin coating thereon; (c) optionally applying a reinforcing mesh tape to the polyolefin coating formed in step (a); (d) applying a second layer of reactive polyolefin blend to said reinforcing mesh tape or first polyolefin coating to form a second polyolefin coating; (d) optionally subjecting the (optionally reinforced) second polyolefin coating to a source of energy, thereby partially or fully cross-linking said reinforced polyolefin coating, transforming said (optionally reinforced) second polyolefin coating into a partially or fully cross-linked reinforced polyolefin coating; and (e) rapidly cooling said cross-linked reinforced polyolefin coating.

In certain embodiments, the applying of the reactive polyolefin blend comprises an extrusion onto said exterior surface of a hot, melted, reactive polyolefin blend.

In certain embodiments, the applying of the reactive polyolefin blend comprises a powder coating of said exterior surface with said reactive polyolefin blend.

In certain embodiments, the applying of the reactive polyolefin blend comprises both a powder coating of said exterior surface with the reactive polyolefin blend and an extrusion onto said exterior surface of a hot, melted, reactive polyolefin blend.

In certain embodiments, the method further comprises, in-line, and prior to step (a): (f) cleaning the exterior surface.

In certain embodiments, the method further comprises, in-line, and prior to step (a): (g) heating the exterior surface.

In certain embodiments, the method further comprises, in-line, prior to step (a): (h) applying an anti-corrosion layer.

In certain embodiments, the first reactive polyolefin coating comprises polyolefin, irganox 1010+/−Irgafos 168, E265, Wollastonite Nyad 400, Epoxy DER6155, and optionally polyethylene.

In certain embodiments, the first reactive polyolefin coating comprises, by weight, 93-94% polyethylene, 0-0.8% black master batch, 0.2-0.5% irganox 1010+/−Irgafos 168, 3-4% E265, 0.5-1.0% wollastonite Nyad 400, and 0.5-1% Epoxy DER 6155.

In certain embodiments, the second reactive polyolefin coating comprises: polyethylene; a masterbatch formulation comprising E265 or equivalent, wollastonite NYAD-400, irganox 1010+/−Irgafos 168, DER 6155, and optionally polyethylene; and optionally black masterbatch.

In certain embodiments, the second reactive polyolefin coating comprises, by weight: 90-92% polyethylene; 4-5% black masterbatch; and 3-5% masterbatch formulation comprising by weight 50-62% E265 or equivalent, 0-17.5% polyethylene, 10-20% wollastonite NYAD-400, 0.2-0.5% Irganox 1010+/−Irgafos168, and 10-20% DER 6155.

According to a further aspect of the invention is provided a masterbatch composition comprising: E265 or equivalent, wollastonite NYAD-400, irganox 1010+/−Irgafos 168, DER 6155, and optionally polyethylene.

In certain embodiments, the masterbatch composition comprises by weight 50-62% E265 or equivalent, 0-17.5% polyethylene, 10-20% wollastonite NYAD-400, 0.2-0.5% Irganox 1010+/−Irgafos168, and 10-20% DER 6155.

According to a further aspect of the present invention is provided a reactive polyolefin composition comprising the masterbatch composition as herebefore described, polyethylene, and optionally black masterbatch.

In certain embodiments, the reactive polyolefin composition comprises by weight: 3-5% of the masterbatch composition of claim 13, 90-92% polyethylene, and 4-5% black master batch.

According to a further embodiment of the present invention is provided a reactive polyolefin composition comprising polyethylene, Irganox 1010+/−Irgafos 168, E265, Wollastonite Nyad 400, and optionally black master batch.

In certain embodiments, the reactive polyolefin composition comprises by weight: 93-94% polyethylene, 0-0.8% black masterbatch, 0.2-0.5% Irganox 1010+/−Irgafos168, 3-4% E265, 0.5-1% Wollastonite Nyad400, and 0.5-1% Epoxy DER 6155.

According to another aspect of the invention is provided a method for coating an elongate metallic tubular article having an exterior surface and an interior surface, comprising, in-line: (a) heating the elongate metallic tubular article; (b) powder coating the elongate metallic tubular article with a fusion bonded epoxy to form a fusion bonded epoxy coated article; (c) before the fusion bonded epoxy has fully set, powder coating the fusion bonded epoxy coated article with a reactive polyolefin blend to form a first reactive polyolefin coating; (d) optionally applying a reinforcing mesh tape to the first reactive polyolefin coating, optionally before the first reactive polyolefin coating has set; (e) before the first reactive polyolefin coating has set, extruding a second reactive polyolefin blend onto the first reactive polyolefin coating; (f) subjecting the resultant reactive polyolefin coating to a source of energy, thereby partially or fully cross-linking said reactive polyolefin coating, transforming said reactive polyolefin coating into a cross-linked polyolefin coating; and (g) rapidly cooling said cross-linked polyolefin coating.

According to yet a further aspect of the present invention is provided method for coating an elongate metallic tubular article having an exterior surface and an interior surface, comprising, in-line: (a) heating the elongate metallic tubular article; (b) powder coating the elongate metallic tubular article with a fusion bonded epoxy to form a fusion bonded epoxy coated article; (c) before the fusion bonded epoxy has fully set, extruding onto the fusion bonded epoxy coated article a reactive polyolefin blend to form a first reactive polyolefin coating; (d) optionally applying a reinforcing mesh tape to the first reactive polyolefin coating, optionally before the first reactive polyolefin coating has set; (e) before the first reactive polyolefin coating has set, extruding a second reactive polyolefin coating onto the first reactive polyolefin coating; (f) subjecting the resultant polyolefin coating to a source of energy, thereby partially or fully cross-linking said polyolefin coating, transforming said polyolefin coating into a cross-linked polyolefin coating; and (g) rapidly cooling said cross-linked polyolefin coating.

In certain embodiments, the extruding in step (c) and the extruding in step (e) utilize a single extruder.

In certain embodiments, the extruding in step (c) and the extruding in step (e) utilize separate extruders.

According to a further embodiment of the present invention is provided a method for coating an elongate metallic tubular article having an exterior surface and an interior surface, comprising, in-line: (a) heating the elongate metallic tubular article; (b) powder coating the elongate metallic tubular article with a blend of a fusion bonded epoxy and a reactive polyolefin blend to form a fusion bonded epoxy/reactive polyolefin coating; (c) subjecting the fusion bonded epoxy/reactive polyolefin coating to a source of energy, thereby partially or fully cross-linking said polyolefin coating, transforming said polyolefin coating into a cross-linked polyolefin coating; and (d) rapidly cooling said cross-linked polyolefin coating.

According to a further aspect of the present invention is provided a method for coating an elongate metallic tubular article having an exterior surface and an interior surface, comprising, in-line: (a) heating the elongate metallic tubular article; (b) powder coating the elongate metallic tubular article with a blend of a fusion bonded epoxy and a reactive polyolefin blend to form a fusion bonded epoxy/reactive polyolefin coating; (c) extruding or powder coating the fusion bonded epoxy/reactive polyolefin coating with reactive polyolefin blend to form a reactive polyolefin coating; (d) subjecting the reactive polyolefin coating to a source of energy, thereby partially or fully cross-linking said polyolefin coating, transforming said polyolefin coating into a cross-linked polyolefin coating; and (e) rapidly cooling said cross-linked polyolefin coating.

In certain embodiments, the blend of fusion bonded epoxy and reactive polyolefin blend is a 30:70 weight ratio of fusion bonded epoxy to reactive polyolefin blend.

In certain embodiments, the blend of fusion bonded epoxy and reactive polyolefin blend is a homogeneous blend.

According to yet a further aspect of the present invention is provided an apparatus for coating a moving elongate metallic tubular article, comprising: (a) a heating station; (b) a powder coating station; (c) an extruding station; (d) an energy source station; (e) a cooling device station; and (f) a conveying assembly for moving the elongate metallic tubular article between stations.

In certain embodiments, the extruding station comprises a flat extrusion die or a circular extrusion die.

In certain embodiments, the energy source station comprises a source of infra-red energy, a source of ultra-violet energy, an electron beam, a source of microwave energy, an induction coil, a source of hot air, and/or a convection oven.

According to a further aspect of the present invention is provided a composition comprising fusion bonded epoxy powder and a reactive polyolefin blend powder.

In certain embodiments, the composition has a mean particle size of 300 microns or less.

In certain embodiments, the weight ratio of fusion bonded epoxy powder and reactive polyolefin blend powder in the composition is about 1-99, preferably 30:70.

In certain embodiments, the fusion bonded epoxy powder and the reactive polyolefin blend in the composition are a homogeneous blend.

### BRIEF DESCRIPTION OF THE DRAWINGS

Reference will now be made, by way of example, to the accompanying drawings which show example embodiments of the present application, and in which:

FIG. 1 is a schematic depicting a prior art apparatus for coating a moving elongate metallic tubular article;

FIG. 2 is a schematic depicting a prior art apparatus for coating a moving elongate metallic tubular article;

FIG. 3 is a schematic depicting a prior art apparatus for coating a moving elongate metallic tubular article;

FIG. 4 is a schematic depicting a prior art apparatus for coating a stationary elongate metallic tubular article;

FIG. 5 is a schematic depicting a prior art apparatus for coating a moving elongate metallic tubular article.

FIG. 6 is a schematic depicting an apparatus for coating a moving elongate metallic tubular article according to the present invention.

FIG. 7 is a schematic depicting an apparatus for coating a moving elongate metallic tubular article according to the present invention.

FIG. 8 is a schematic depicting an apparatus for coating a moving elongate metallic tubular article according to the present invention.

FIG. 9 is a schematic depicting an apparatus for coating a moving elongate metallic tubular article according to the present invention.

FIG. 10 is a schematic depicting an apparatus for coating a moving elongate metallic tubular article according to the present invention.

FIG. 11 is a schematic depicting an apparatus for coating a moving elongate metallic tubular article according to the present invention.

Similar reference numerals may have been used in different figures to denote similar components.

### DESCRIPTION

Polyolefin compositions useful for coating pipe are well known. A wide variety of such polyolefin compositions are described in PCT/CA2013/050765 and PCT/CA2015/050337, incorporated herein by reference. A subset of such polyolefin compositions are reactive polyolefin blends, which can be cross-linked using UV or another known method for cross-linking polyolefin or increasing the amount of cross-linking in a polyolefin surface.

Reactive polyolefin blends for coating pipe comprise polyolefin, (often based primarily on polyethylene and/or polypropylene), blended with reactive polyolefins, such as amino silane, maleic anhydride, etc. Reactive polyolefins have reactive sites, such as borane, benzylic protons, styrenes, silanes, etc., which promote cross-reaction. Reactive polyolefin blends may also contain grafted polyolefin, adhesion promoter, filler, epoxy resin and/or curing agent, UV stabilizer, curing agent, etc. Reactive polyolefin blends can be formulated as generally homogeneous, solid pellets of a size and shape suitable for loading into the hopper of an extruder, and extruded, hot and melted, through an extrusion die onto a pipe surface. Reactive polyolefin blends may also be provided in fine particulate form suitable for spray application.

It has been found that, for spray application, reactive polyolefin blends having a lower viscosity polyolefin is preferable. For the extrudable pellets, described above, it was found that polyethylene with a melt index of approximately 2.0 to 5.0 (190° C./2.16 kg/10 min) worked extremely well. However, for a spray-able composition, a lower viscosity was found to work better—it was found that a polyethylene with a melt index of about 2.0-17 (190° C./2.16 kg/10 min) was better suited for spray coating.

Further, for sprayable compositions, it was found that a smaller particle size was advisable. The pellets described above for extrusion/melt applications were not optimal for spraying using conventional, commercially available, powder spray guns. A much smaller particle, having a mean particle size of less or equal to 300 microns, was preferable.

### Polyolefin/FBE Blend Compositions

Traditionally and as hereinbefore described, pipes have been coated with a first thin layer of fusion bonded epoxy, for corrosion and water resistance, followed by a second, polyolefin layer for impact resistance etc.

It has been surprisingly found that the two layers can be replaced by a single layer coating that is applied by powder spray coating, said single layer coating being a blend of FBE powder and reactive polyolefin blend in powder form. Previously, this was not thought possible, in part due to the dramatic differences in melting points for the polyolefin powder and the FBE powder. However, surprisingly, this dramatic difference in melting point is thought to actually aid in the process.

The reactive polyolefin blend suitable for spray coating is blended with a fusion bonded epoxy (FBE) also suitable for spray coating. In a preferred embodiment, the blending is a homogenous blending. In certain embodiments, a 70:30 (w/w) blend of polyolefin: FBE is used. Surprisingly, a homogeneous blend of this nature, spray coated onto a hot pipe, will result in the formation of a coating having a gradient, with a higher concentration of FBE at the pipe/coating interface, and a higher concentration of polyolefin at the outer surface of the coating. Without being limited to any particular theory, it is believed that this is due primarily (or at least in part) to the difference in melting points of the polyolefin powder vs. the FBE powder. This results in all or most of the corrosion-protection advantages of a two layer FBE/polyolefin pipe coating in an easy to apply single coating, with a primarily FBE coated inner coating, a primarily polyolefin coated outer coating, in a gradient.

### Method of Coating

As noted above, the specification also discloses a new method for coating a metallic article. The method enables, for instance, the coating of a metallic elongate article, such as a steel pipe used in oil, gas and water pipeline, with a cross-linked, or partially cross-linked, polyolefin coating that provides excellent moisture, impact, and corrosion resistance. The entire coating process can be performed “in-line”, in a series of steps in the same manufacturing facility, for example, in the same pipe conveying apparatus.

The process includes the steps of applying a reactive polyolefin blend to the exterior surface of the pipe, partially or fully cross-linking the polyolefin in situ, through the application of one or more source of energy such as a source of infra-red energy, then rapidly cooling the coating. The method provides ease of application of the polyolefin, since it is applied in a reactive, but non-crosslinked form, and thus can be applied at a relatively low temperature, which is still hot enough to melt the reactive polyolefin blend. The method also provides the excellent, hard, durable and impact and moisture resistant surface of a partially or fully cross-linked polyolefin. The method provides ease and low cost, since the crosslinking process can (optionally) occur before the coating has time to cool.

The application of the reactive polyolefin blend can be, for example, through a hot melt extrusion process, wherein the reactive polyolefin blend is heated, then extruded at a temperature of about 180° C., onto the pipe, using a flat die, or alternatively a circular die surrounding the pipe. In this manner, an even coating of hot, melted, reactive polyolefin blend is applied to and coats the pipe. The pipe may have been previously treated or coated. For example, the pipe may have been previously coated with a fusion bonded epoxy or liquid epoxy, or an adhesive, or both an epoxy and an adhesive, either as a laminate or a blend. In the case of a flat die, the die can rotate around the pipe, or in alternative configurations, the pipe itself could be rotating as it passes the die.

The term “crosslinkable”, when utilized herein, means a non-crosslinked or partially crosslinked material that can be further crosslinked through the application of an energy, such as infra red heat, gamma radiation, UV light, or electron beam exposure, or a combination thereof.

The term “crosslinked”, when utilized herein, means a partially or fully crosslinked polyolefin material. The crosslinking can be uniform, wherein the entire bulk of the polymer has about the same cross-link density, or non-uniform, for example, a gradient crosslink, where the portion of the crosslinked material closest to the pipe has less cross-link density than the material furthest from the pipe. For example, a form of energy that does not go through the entirety of the coating can be utilized, to form a gradient crosslink.

The source of energy used can be any source of energy which results in an increase in the cross-link density of the reactive polyolefin blend. For example, the source can be a source of infra-red energy, a source of ultra-violet energy, an electron beam, a source of microwave energy, an induction coil, a source of hot air, or even a standard convection oven. A combination of sources can also be used. For example the source of energy can be an infra-red heating element. The infra-red heating element, such as an infra-red coil, is configured to heat the coating to above 200° C., typically to 220-240° C., preferably 220-225° C. for 5-30 seconds.

In one embodiment, the method is provided with a temperature detector to detect the temperature of the coating composition, to ensure that the temperature is maintained in the range as required by the application requirements, for crosslinking the polyolefin. In a further embodiment, a feedback loop can be provided, along with appropriate controls. The feedback loop connects the temperature detector with the source of energy. While the controls allow the source of energy to be manipulated to ensure that the crosslinking process of the coating composition is maintained in an appropriate range, as required by the application requirements and the components used.

In a further embodiment in accordance with the specification, cooling or rapid cooling can also be performed. The rapid cooling can be a cold water quenching, either by applying a stream of water to the outside of the coated pipe, and/or to its inside. In certain embodiments, the stream of water is a laminar flow of water on the outside of the pipe. Use of such a laminar flow of water decreases surface imperfections caused by the water when cooling the hot polyolefin surface.

In many embodiments, the exterior surface of the elongate metallic article can be cleaned before application of the reactive polyolefin blend. The cleaning can be to remove surface dirt, sand, or rust, and can include a hot water wash, blasting and/or acid washing the surface. Acid washing can be done with phosphoric acid at a concentration of 4-15%, typically 5%, with a dwell time from 15-30 seconds, followed by rinsing with high pressure (1200 psi minimum) deionized water to ensure no residual acid is left on the surface of the pipe. Preferably, the cleaning is also done in-line, immediately before the application of reactive polyolefin blend, or immediately before the application of the first coating onto the metallic surface, where there is a coating between the metallic surface and the reactive polyolefin blend, as described further, below.

Preferably, the surface of the pipe is also heated immediately prior to the application of the reactive polyolefin coating (and/or immediately before the application of the first coating onto the metallic surface, where there is a coating between the metallic surface and the reactive polyolefin blend, as described further, below). The heating of the pipe allows the hot melted reactive polyolefin blend to better bond to the pipe surface, and prevents localized cooling and setting of the reactive polyolefin blend as it hits the pipe surface. Preferably, the pipe is heated to an external surface temperature of 220-240° C., though a lower pre-heat temperature, for example, 160° C.-220° C., may also be desirable for certain applications, for example, with the use of a low application temperature fusion bonded epoxy (LAT FBE) layer as the first coating.

In certain embodiments, it is desirable to have a multi-layer coating on the metallic pipe, with the crosslinked polyolefin coating being the external coating and surface of a laminate. For instance, it may be desirable to apply an anti-corrosion layer, for instance, an epoxy coating layer, which may be a fusion bonded epoxy or a liquid epoxy, to the exterior surface of the pipe before the application of the reactive polyolefin blend. This may be done, again, in-line, by painting or spraying a liquid epoxy, or spray coating a fusion bonded epoxy, to the hot pipe, using conventional methods, preferably 5-15 seconds before application of the reactive polyolefin blend. For spray coating, the pipe should be hot, for example, 220-240° C. for a traditional fusion bonded epoxy, or 160-220° C. for a LAT FBE coating.

Instead of, or in addition to, the epoxy coating, it may be desirable to apply an adhesive layer as part of the laminate, either between the epoxy coating and the reactive polyolefin blend coating, or between the metal of the pipe and the reactive polyolefin blend coating in embodiments that may or may not include the epoxy coating layer. Here, again, the adhesive layer may be extruded or sprayed onto the exterior surface of the pipe (or onto the epoxy coating, as appropriate), in line, using conventional methods, immediately before application of the reactive polyolefin blend. The use of an adhesive layer is particularly advantageous where there is a spiral weld on the metallic pipe.

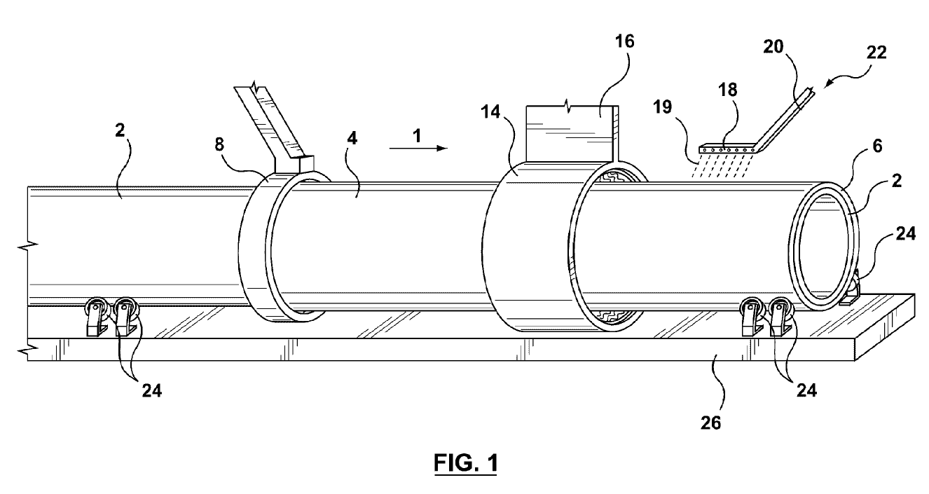

FIG. 1 shows a schematic of an apparatus as taught in the prior art. A metal pipe 2 is conveyed in direction 1 along a conventional conveying assembly, comprising a conveyor frame 26 and conveying wheels 24. In this particular embodiment, the metal pipe is conveyed without significant rotational movement. Pipe 2 is conveyed through a circular extrusion die 8 through which a flow of melted, reactive polyolefin blend 12 is extruded, onto the surface of the pipe 2 to form a reactive polyolefin coating 4. Pipe 2 is then conveyed through an infra-red heater 14 mounted on infra-red heater frame 16 and surrounding the pipe 2. The infra-red heater 14 applies infra-red energy for 5-25 seconds to the reactive polyolefin coating 4, partially or fully cross-linking it to form cross-linked polyolefin coating 6. The pipe 2 having cross-linked polyolefin coating 6 is then conveyed through water dispensing system 18 which dispenses cool water 19 onto the pipe 2, rapidly cooling the cross-linked polyolefin coating 6. It would be appreciated that the speed of the conveying of the pipe 2, the rate/speed of reactive polyolefin blend 12 extruded through the die 8, and the thickness of the opening in the die 8, will contribute to the thickness of reactive polyolefin coating 4. In addition, the speed of the conveying of the pipe 2, the amount, wavelength, and proximity of the energy transmitted by infra-red heater 14, and the length of the infra-red heater 14 will all contribute to the amount of cross-linking in cross-linked polyolefin coating 6. All these parameters can easily and readily be adjusted to obtain the desired pipe coating characteristics.

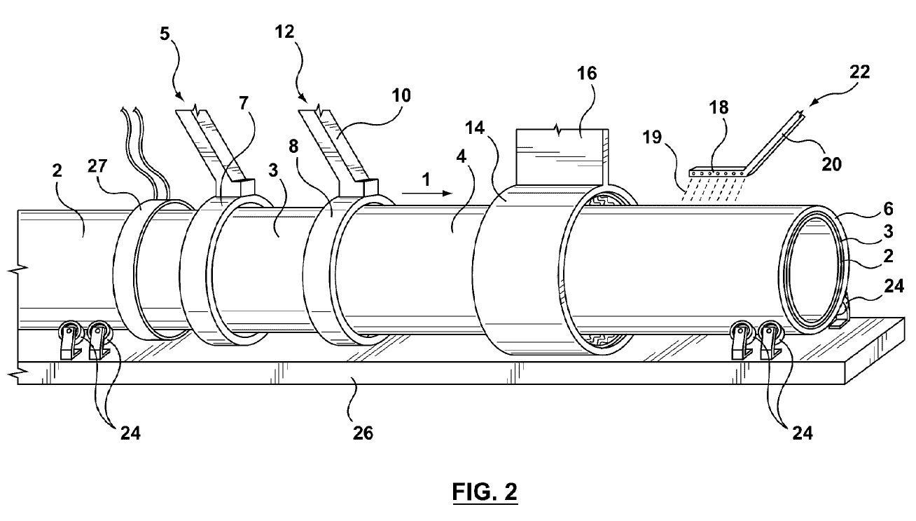

FIG. 2 shows a schematic of an apparatus as taught in the prior art. Metal pipe 2 is conveyed along a conventional conveying assembly, comprising a conveyor frame 26 and conveying wheels 24. In this particular embodiment, the metal pipe 2 is conveyed without significant rotational movement. Pipe 2 is conveyed through a pre-heater 27 which preheats the pipe to the required temperature. The pipe 2 is then conveyed through powder coater 7 which in turn is connected to a source of powdered fusion bonded epoxy 5. The powder coater 7 applies the powdered fusion bonded epoxy to the hot pipe 2 to form a fusion bonded epoxy coated pipe surface, or fusion bonded epoxy coating 3. The pipe 2 is then conveyed through a circular extrusion die 8 through which a flow of melted, reactive polyolefin blend 12 is extruded, onto the surface of the pipe 2 to form a reactive polyolefin coating 4. Pipe 2 is then conveyed through an infra-red heater 14 mounted on infra-red heater frame 16 and surrounding the pipe 2. The infra red heater 14 applies infra-red energy for 5-25 seconds to the reactive polyolefin coating 4, partially or fully cross-linking it to form cross-linked polyolefin coating 6. The pipe 2 having cross-linked polyolefin coating 6 is then conveyed through water dispensing system 18 which dispenses cool water 19 onto the pipe 2, rapidly cooling the cross-linked polyolefin coating 6. It would be appreciated that the speed of the conveying of the pipe 2, the rate/speed of reactive polyolefin blend 12 extruded through the die 8, and the thickness of the opening in the die 8, will contribute to the thickness of non-crosslinked polyolefin coating 4. In addition, the speed of the conveying of the pipe 2, the amount, wavelength, and proximity of the energy transmitted by infra-red heater 14, and the length of the infra-red heater 14 will all contribute to the amount of cross-linking in cross-linked polyolefin coating 6. It would also be appreciated that the speed of the conveying of the pipe 2, and the rate at which FBE is sprayed onto the pipe by powder coater 7 will both contribute to the thickness of the fusion bonded epoxy coating 3. All these parameters can easily and readily be adjusted to obtain the desired pipe coating characteristics. It would also be appreciated that the infra-red heater may be replaced by another source of energy, such as a standard oven, or, in some embodiments, may not even be necessary at all.

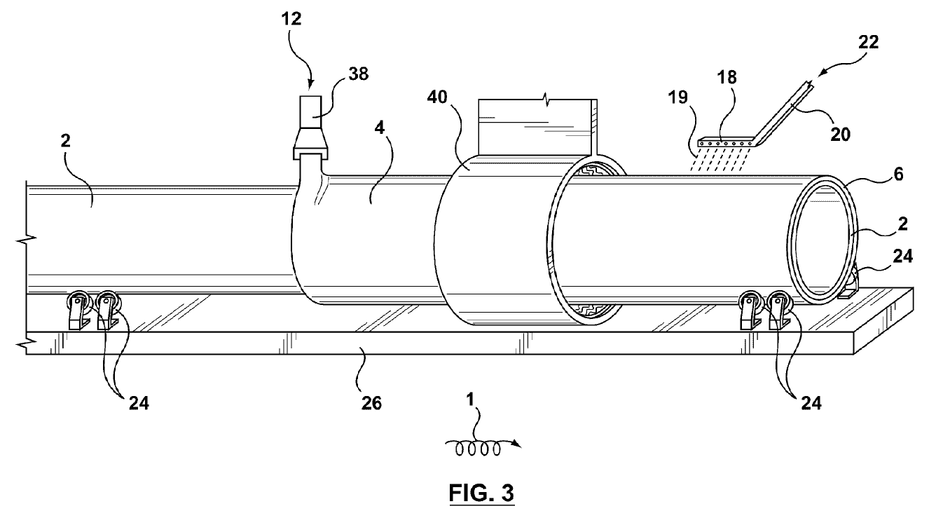

FIG. 3 shows a schematic of an apparatus as taught in the prior art. A metal pipe 2 is conveyed in direction 1 along a conventional conveying assembly, comprising a conveyor frame 26 and conveying wheels 24. In this particular embodiment, the metal pipe is conveyed both longitudinally and rotationally, i.e. the pipe rotates as it moves forward along the conveying apparatus. Pipe 2 is conveyed through a flat extrusion die 38 through which a flow of melted, reactive polyolefin blend 12 is extruded, onto the surface of the pipe 2. Since the pipe is rotating, the flow of melted, reactive polyolefin blend 12 forms a coating on the entire surface of pipe 2—reactive polyolefin coating 4. Pipe 2 is then conveyed through an infra-red heater 40, which applies infra-red energy for 5-25 seconds to a portion of the reactive polyolefin coating 4, cross-linking it to form cross-linked polyolefin coating 6. The pipe 2 having cross-linked polyolefin coating 6 is then conveyed through water dispensing system 18 which dispenses cool water 19 onto the pipe 2, rapidly cooling the cross-linked polyolefin coating 6. It would be appreciated that the speed of the conveying and of the rotating of the pipe 2, the rate/speed of reactive polyolefin coating 12 extruded through the die 8, and the thickness of the opening in the die 8, will contribute to the thickness of reactive polyolefin coating 4. In addition, the speed of the conveying and the rotating of the pipe 2, the amount, wavelength, and proximity of the energy transmitted by infra-red heater 14, and the length of the infra-red heater 14 will all contribute to the amount of cross-linking in cross-linked polyolefin coating 6. All these parameters can easily and readily be adjusted to obtain the desired pipe coating characteristics.

It would also be appreciated that the additional elements as shown in FIG. 2 (pre-heater, powder coater, etc.) could also be utilized in a method with a rotating pipe as described in FIG. 3.

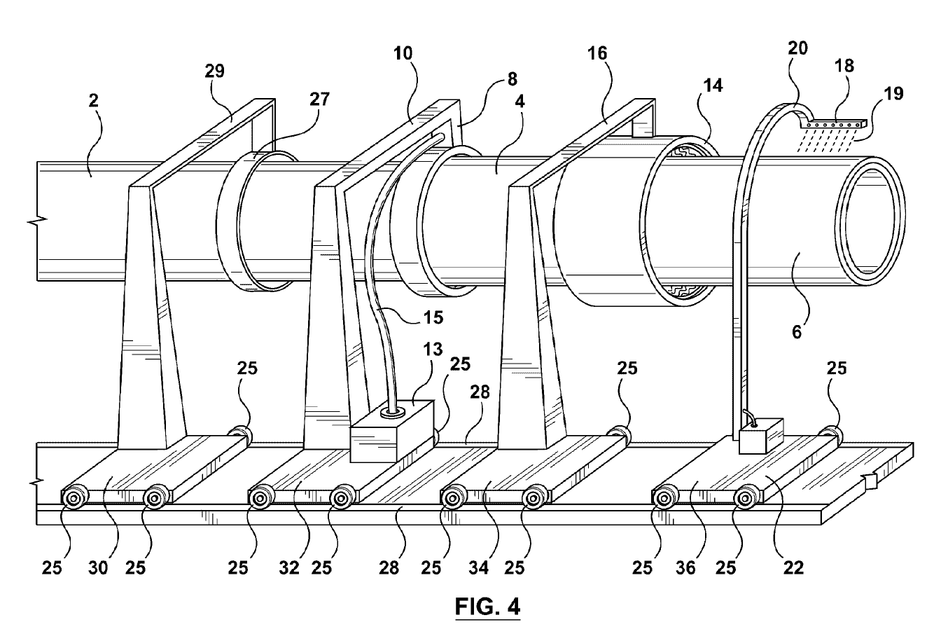

FIG. 4 shows a schematic of an apparatus of the prior art. The embodiment shown in FIG. 4 is of particular use in coating a pipe already in the field, or where the pipe is of a length that is unmanageable for conveying as described in the methods of FIGS. 1-3. In this method, the pipe remains stationary. A track 28 is placed proximal and generally parallel to the pipe. A plurality of carts (pre-heater cart 30, extruder cart 32, IR heater cart 34, and cooling cart 36) are placed on the track 28. The carts (30, 32, 34, 36) each comprise wheels 25 which allow displacement of the carts (30, 32, 34, 36) along the track 28. Thus the carts 30, 32, 34, 36 are displaceable along side of the length of the pipe 2, and generally parallel to it. Cart 30 is a pre-heater cart comprising pre-heater 27. Pre-heater 27 is mounted to an arm 29 and has two configurations, an open configuration, and (as shown) a closed configuration. Arm 29 can swivel and adjust. Thus, when pre-heater cart 30 is on track 28, pre-heater 27 can be mounted to surround pipe 2 and travel along pipe 2 when cart 30 is displaced along track 28. Likewise, extruder cart 32 comprises circular extrusion die 8 which can be configured to surround pipe 2 and through which a flow of melted, reactive polyolefin blend is extruded, onto the surface of the pipe 2 to form a reactive polyolefin coating 4. The extruder cart 32 also comprises an extruder 13 in which is placed reactive polyolefin blend. The hot, melted, reactive polyolefin blend is displaced from extruder 13 through circular extrusion die 8 through conduit 15. IR heater cart 34 likewise comprises infra-red heater 14, which is mounted to a frame 16 that is adjustable. Infra-red heater 14 has two configurations, an open configuration and (as shown) a closed configuration. Frame 16 can swivel and adjust. Thus, when IR heater cart 34 is on track 28, infra-red heater 14 can be mounted to surround pipe 2 and travel along pipe 2 when cart 34 is displaced along track 28. Finally, FIG. 4 schematically shows cooling cart 36 which comprises water dispensing system 18 attached to arm 20. Water dispensing system 18 dispenses cool water 19 onto the pipe 2, rapidly cooling the partially or fully cross-linked polyolefin coating 6. Also shown is water input 22.

As would be appreciated by a person in the art, the system shown in FIG. 4 can be used in the field, on a pre-installed pipe. It can also be used on pipe lengths of non-standard size, for example, for coating small pipe lengths that would not otherwise fit on a conveying assembly of FIGS. 1-3, or curved or non-standard shaped pipes. As would be appreciated, although pre-heater 27, infra-red heater 14, and extrusion die 8 are shown having two configurations, for placement onto a pipe, this is an optional embodiment; a simpler apparatus can be made where these components only have one configuration (closed and as shown), and are placed on a pipe length by threading the end of the pipe through them.

As would also be appreciated by a person of skill in the art, the use of individual carts as shown in FIG. 4 allows for a high amount of flexibility in the method. For example, a powder coating cart (not shown), configured to spray coat fusion bonded epoxy powder, could be placed between the pre-heater cart 30 and the extruder cart 32 in applications where a fusion bonded epoxy coating is desired. Alternatively, multiple processes can be integrated on one cart—for example, a single cart could have both the extrusion and the infra-red heater components.

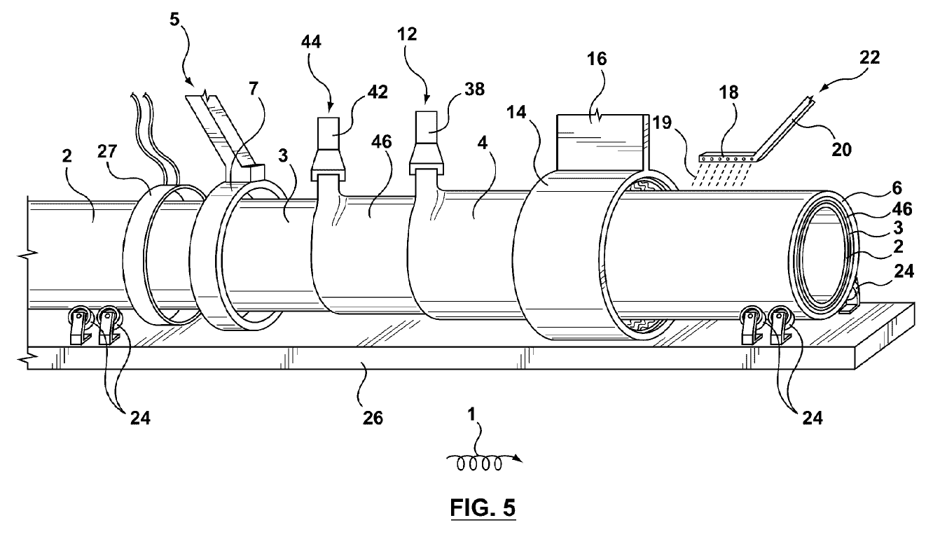

FIG. 5 shows a schematic of an apparatus of the prior art. Metal pipe 2 is conveyed in direction 1 along a conventional conveying assembly, comprising a conveyor frame 26 and conveying wheels 24. In this particular embodiment, the metal pipe is conveyed both longitudinally and rotationally, i.e. the pipe rotates as it moves forward along the conveying apparatus. Pipe 2 is conveyed through a pre-heater 27 which preheats the pipe to the required temperature. The pipe 2 is then conveyed through powder coater 7 which in turn is connected to a source of powdered fusion bonded epoxy 5. The powder coater 7 applies the powdered fusion bonded epoxy to the hot pipe 2 to form a fusion bonded epoxy coated pipe surface, or fusion bonded epoxy coating 3. The pipe 2 is then conveyed through a spray coater 42 which is in turn connected to a source of reactive polyolefin blend 44. The spray coater 42 applies/extrudes the reactive polyolefin blend to the hot pipe 2 to form a reactive polyolefin pipe surface, or adhesive coating 46. The pipe 2 is then conveyed through a flat extrusion die 38 through which a flow of melted, reactive polyolefin 12 is extruded, onto the surface of the pipe 2. Since the pipe is rotating, the flow of melted, reactive polyolefin 12 forms a coating on the entire surface of pipe 2—reactive polyolefin coating 4. Pipe 2 is then conveyed through an infra-red heater 14 mounted on infra-red heater frame 16 and surrounding the pipe 2. The infra red heater 14 applies infra-red energy for 5-25 seconds to the reactive polyolefin coating 4, partially or fully cross-linking it to form cross-linked polyolefin coating 6. The pipe 2 having cross-linked polyolefin coating 6 is then conveyed through water dispensing system 18 which dispenses cool water 19 onto the pipe 2, rapidly cooling the cross-linked polyolefin coating 6. It would be appreciated that the speed of the conveying and of the rotating of the pipe 2, the rate/speed of reactive polyolefin 12 extruded through the die 38, and the thickness of the opening in the die 38, will contribute to the thickness of reactive polyolefin coating 4. In addition, the speed of the conveying and the rotating of the pipe 2, the amount, wavelength, and proximity of the energy transmitted by infra-red heater 14, and the length of the infra-red heater 14 will all contribute to the amount of cross-linking in cross-linked polyolefin coating 6. It would also be appreciated that the speed of the conveying and the rotating of the pipe 2, and the rate at which FBE is sprayed onto the pipe by powder coater 7 will both contribute to the thickness of the fusion bonded epoxy coating 3. It would additionally be appreciated that the speed and the rotating of the conveying of the pipe 2, and the rate at which adhesive is sprayed onto the pipe by spray coater 42, will contribute to the thickness of adhesive coating 46. It would also be appreciated that infra-red heater may be replaced by another form of energy, such as a conventional oven, or may, in some embodiments, be optional. All these parameters can easily and readily be adjusted to obtain the desired pipe coating characteristics.

### Multiple Coatings

In certain embodiments, it is advantageous to add the melted, reactive polyolefin blend 12 coating in multiple coats. For example, to achieve a 1.5 mm coating of polyolefin, it can be advantageous to configure the speed of conveying, rotating of the pipe, rate/speed of reactive polyolefin blend 12 extruded through the die 38, and the thickness of the opening in the die 38 to extrude a 0.3 to 0.5 mm thick layer of reactive polyolefin 12 coating. The pitch and speed of the pipe rotation and forward movement allow variation in amount of overlap; by overlapping several times, a thicker coating can be formed.

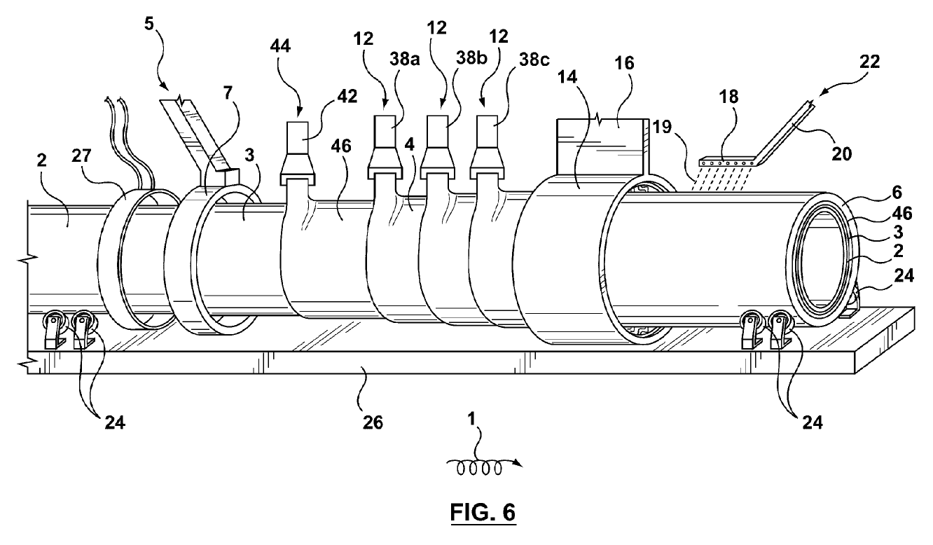

FIG. 6 shows a schematic of an apparatus for applying melted reactive polyolefin blend 12 in multiple coats. As with FIG. 5, metal pipe 2 is conveyed in direction 1 along a conventional conveying assembly, comprising a conveyor frame 26 and conveying wheels 24. In this particular embodiment, the metal pipe is conveyed both longitudinally and rotationally, i.e. the pipe rotates as it moves forward along the conveying apparatus, though this is optional—instead, the apparatus could be configured with circular dies and the pipe would not rotate. Pipe 2 is conveyed through a pre-heater 27 which preheats the pipe to the required temperature. The pipe 2 is then conveyed through powder coater 7 which in turn is connected to a source of powdered fusion bonded epoxy 5. The powder coater 7 applies the powdered fusion bonded epoxy to the hot pipe 2 to form a fusion bonded epoxy coated pipe surface, or fusion bonded epoxy coating 3. The pipe 2 is then conveyed through a spray coater 42 which is in turn connected to a source of reactive polyolefin blend 44. The spray coater 42 applies/extrudes the reactive polyolefin blend 44 to the hot pipe 2 to form a reactive polyolefin blend coated pipe surface 46, or adhesive coating. The pipe 2 is then conveyed through a plurality of flat extrusion dies 38a, 38b, 38c through which each a flow of melted, reactive polyolefin 12 is extruded, onto the surface of the pipe 2. Since the pipe is rotating, the flow of melted, reactive polyolefin 12 forms a coating on the entire surface of pipe 2—reactive polyolefin coating 4. Each extrusion die 38a, 38b, and 38c is capable of applying multiple coats of polyolefin—as such, only one of such dies is necessary for each type of polyolefin blend used. By using multiple flat extrusions dies 38a, 38b and 38c as shown, each is able to apply different compositions of polyolefin, to create a pipeline coating with varying properties through its thickness. Pipe 2 is then conveyed through an infra-red heater 14 mounted on infra-red heater frame 16 and surrounding the pipe 2. The infra-red heater 14 applies infra-red energy for 5-25 seconds to the reactive polyolefin coating 4, partially or fully cross-linking it to form cross-linked polyolefin coating 6. The pipe 2 having cross-linked polyolefin coating 6 is then conveyed through water dispensing system 18 which dispenses cool water 19 onto the pipe 2, rapidly cooling the cross-linked polyolefin coating 6. It would be appreciated that the speed of the conveying and of the rotating of the pipe 2, the rate/speed of reactive polyolefin 12 extruded through the die 38, and the thickness of the opening in the dies 38a, b, c, will contribute to the thickness of reactive polyolefin coating 4, by extruding different thicknesses, and allowing for differing amount of overlap causing, in effect, one or more layers (for example, 3-5 layers) of the polyolefin to be applied. In addition, the speed of the conveying and the rotating of the pipe 2, the amount, wavelength, and proximity of the energy transmitted by infra-red heater 14, and the length of the infra-red heater 14 will all contribute to the amount of cross-linking in cross-linked polyolefin coating 6. It would also be appreciated that the speed of the conveying and the rotating of the pipe 2, and the rate at which FBE is sprayed onto the pipe by powder coater 7 will both contribute to the thickness of the fusion bonded epoxy and of the final coating 3. It would additionally be appreciated that the speed and the rotating of the conveying of the pipe 2, and the rate at which adhesive is sprayed onto the pipe by spray coater 42, will contribute to the thickness of adhesive coating 46. It would also be appreciated that the apparatus could have a different configuration, for example, having more than or less than three extrusion dies 38a, 38b, 38c, connected to each individual extruder which, alternatively, could also be connected to its own extruder to allow for different polyolefin blends. It would also be appreciated that infra-red heater 14 could be replaced with another source of energy, such as a conventional oven, or, in certain embodiments, omitted entirely. All these parameters can easily and readily be adjusted to obtain the desired pipe coating characteristics.

### Reinforcing Layer

Particularly but not exclusively in embodiments where the melted, reactive polyolefin blend 12 is added in multiple coats, it may be advantageous, in certain cases, to add a reinforcing layer, for example, a glass fiber mesh tape, between two layers of melted, reactive polyolefin blend. This can be done by having a tape application machine in line between two extrusion outlets. In alternative embodiments, the reinforcing layer can be applied between two extruded layers, eg: between the overlaps of the extruded sheets, while the polyolefin is still hot and at least partially melted, so that the reinforcing layer becomes imbedded within, or partially imbedded within, at least one layer of the polyolefin. In certain embodiments, the reinforcing layer is applied before the first layer of melted, reactive polyolefin blend 12, for example, between an FBE layer and the first layer of melted, reactive polyolefin blend 12, though in preferred embodiments the reinforcing layer is applied between two layers of melted, reactive polyolefin blend 12.

A reinforcing layer is useful to add structural strength and/or impact resistance, and is especially useful for buried pipe applications, to protect the pipe during backfill and in shifting soil.

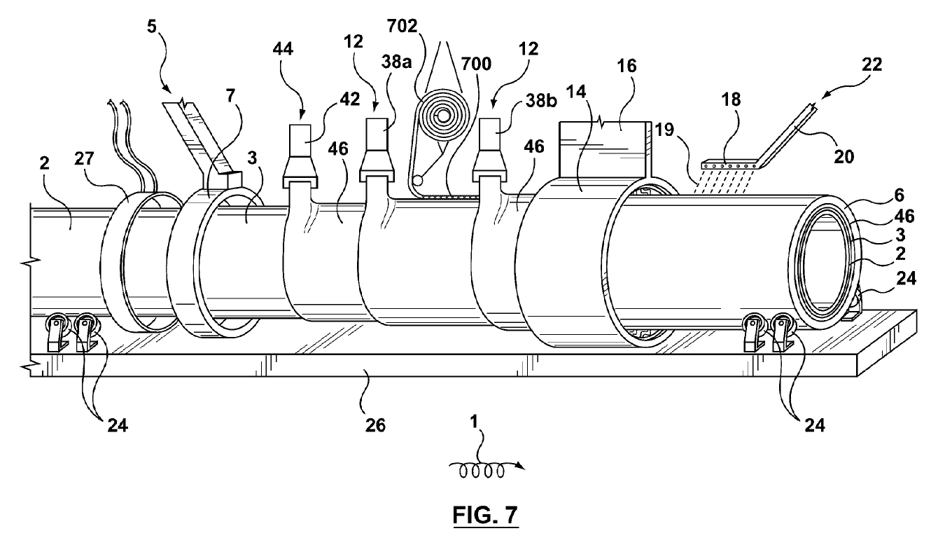

FIG. 7 shows a schematic of an apparatus for applying melted reactive polyolefin blend 12 in multiple coats, with a reinforcing layer 700 in between. As with FIG. 6, metal pipe 2 is conveyed in direction 1 along a conventional conveying assembly, comprising a conveyor frame 26 and conveying wheels 24. In this particular embodiment, the metal pipe is conveyed both longitudinally and rotationally, i.e. the pipe rotates as it moves forward along the conveying apparatus, though this is optional—instead, the apparatus could be configured with circular dies and the pipe would not rotate. Pipe 2 is conveyed through a pre-heater 27 which preheats the pipe to the required temperature. The pipe 2 is then conveyed through powder coater 7 which in turn is connected to a source of powdered fusion bonded epoxy 5. The powder coater 7 applies the powdered fusion bonded epoxy to the hot pipe 2 to form a fusion bonded epoxy coated pipe surface, or fusion bonded epoxy coating 3. The pipe 2 is then conveyed through a spray coater 42 which is in turn connected to a source of adhesive 44. The spray coater 42 applies/extrudes the adhesive to the hot pipe 2 to form an adhesive coated pipe surface, or coating 46. Alternatively, in certain embodiments, a reactive polyolefin blend can be used instead of an adhesive. The pipe 2 is then conveyed through a first flat extrusion die 38a through which a flow of melted, reactive polyolefin blend 12 is extruded, onto the surface of the pipe 2. The pipe 2 is then conveyed through a tape applying machine 702, which wraps a layer of tape 700 around the circumference of the melted, reactive polyolefin blend 12 which had been previously extruded to the pipe. Since the pipe is rotating, the tape is relatively easy to apply, however, in apparatus where the pipe is not rotating; the tape applying machine 702 may rotate around the circumference of the pipe. The tape applying machine 702 is configured to apply sufficient pressure to the tape 700 so that it is embedded into the melted, reactive polyolefin coating 4. In preferred embodiments, the tape applying machine 702 is configured so that the tape 700 is partially embedded into the melted, reactive polyolefin coating 4, but does not penetrate the entirety of the thickness of the melted, reactive polyolefin coating 4. The pipe could then, as in the case of multiple dies, passed through a second flat extrusion die 38b, which applies a further melted, reactive polyolefin blend 4b to the tape layer 700. Since the reactive polyolefin blend 4b is extruded ‘wet’, in preferred embodiments, it will penetrate through tape layer 700, forming a bond with the first melted, reactive polyolefin coating 4. This provides a uniform polyolefin coating with an imbedded reinforcing layer. In certain embodiments, the tape 700 is a reinforcing mesh, for example, a glass fiber, aramid fiber, or carbon fiber mesh tape. In certain embodiments, the melted, reactive polyolefin blend 12 being extruded from each of the flat extrusion dies 38a and 38b is identical in composition, and accordingly forms a uniform, single layer of polyolefin on the pipe, with an imbedded reinforcing layer. In other embodiments, each of flat extrusion dies 38a and 38b may apply different compositions of polyolefin, to create a pipeline coating with varying properties through its thickness, and a reinforcing layer imbedded therein. Like in previous embodiments, Pipe 2 is then conveyed through an infra-red heater 14 mounted on infra-red heater frame 16 and surrounding the pipe 2. The infra red heater 14 applies infra-red energy for 5-25 seconds to the reactive polyolefin coating 4, partially or fully cross-linking it to form cross-linked polyolefin coating 6. The pipe 2 having cross-linked polyolefin coating 6 is then conveyed through water dispensing system 18 which dispenses cool water 19 onto the pipe 2, rapidly cooling the cross-linked polyolefin coating 6. It would be appreciated that the speed of the conveying and of the rotating of the pipe 2, the rate/speed of reactive polyolefin blend 12 extruded through the die 38a, 38b, and the thickness of the opening in the dies 38a, b, will contribute to the thickness of reactive polyolefin coating 4. In addition, the speed of the conveying and the rotating of the pipe 2, the amount, wavelength, and proximity of the energy transmitted by infra-red heater 14, and the length of the infra-red heater 14 will all contribute to the amount of cross-linking in cross-linked polyolefin coating 6. It would also be appreciated that the speed of the conveying and the rotating of the pipe 2, and the rate at which FBE is sprayed onto the pipe by powder coater 7 will both contribute to the thickness of the fusion bonded epoxy coating 3. It would additionally be appreciated that the speed and the rotating of the conveying of the pipe 2, and the rate at which adhesive is sprayed onto the pipe by spray coater 42, will contribute to the thickness of adhesive coating 46. It would also be appreciated that the apparatus could have a different configuration, for example, having more than or less than two extrusion dies 38a, 38b. In cases where it is desired that the polyolefin coming out of the two extrusion dies 38a, 38b are identical, it would be appreciated that the two dies 38a, 38b, could be connected to the same extruder. Alternatively, each could be connected to its own extruder to allow for different polyolefin blends. All these parameters can easily and readily be adjusted to obtain the desired pipe coating characteristics.

### Sprayable Reactive Polyolefin Coating

In certain embodiments, as discussed above, it is advantageous for the reactive polyolefin layer to be applied using a fine powder spray, rather than extruded onto the pipe. In other embodiments, it is advantageous to have an initial, thin, spray coated layer, followed by an extrudate applied as described above. Such a thin spray coated layer provides several advantages. First, this thin layer appears to act as an adhesive, and can replace the application of adhesive as described above. The thin layer can be sprayed immediately after the FBE layer, while the FBE layer is still gelling, and bonds very well with both the FBE layer and the extruded reactive polyolefin layer that follows it. We have found that a thin layer of spray-coated polyolefin provides excellent bonding with the FBE, and provides a desirable “single layer” of polyolefin, bonding with an extruded polyolefin layer that follows it. The extruded polyolefin layer that follows it may have the same composition, or a slightly different composition (for example, a polyethylene component of different viscosity, as described above, or lower or no reactive species), yet still create an essentially single layer of polyolefin coating.

In certain embodiments, and as described further, for example, in Example 9, below, the extruded polyolefintopcoat can be made “in situ” from locally sourced polyolefin (such as locally sourced PE) combined with a master batch formulation. Surprisingly, through the use of a thin sprayed reactive polyolefin (intermediate) layer, we have found excellent results with an extruded polyolefin layer that is as much as 94% locally-sourced polyolefin. This provides the advantages of a compact, highly “concentrated” master batch formulation, which can be made in a highly controlled environment, and stably shipped as a master batch formulation to local sites, where it can be extruded with up to 94% locally-sourced polyolefin powder or pellets. This allows excellent quality control while decreasing costs.

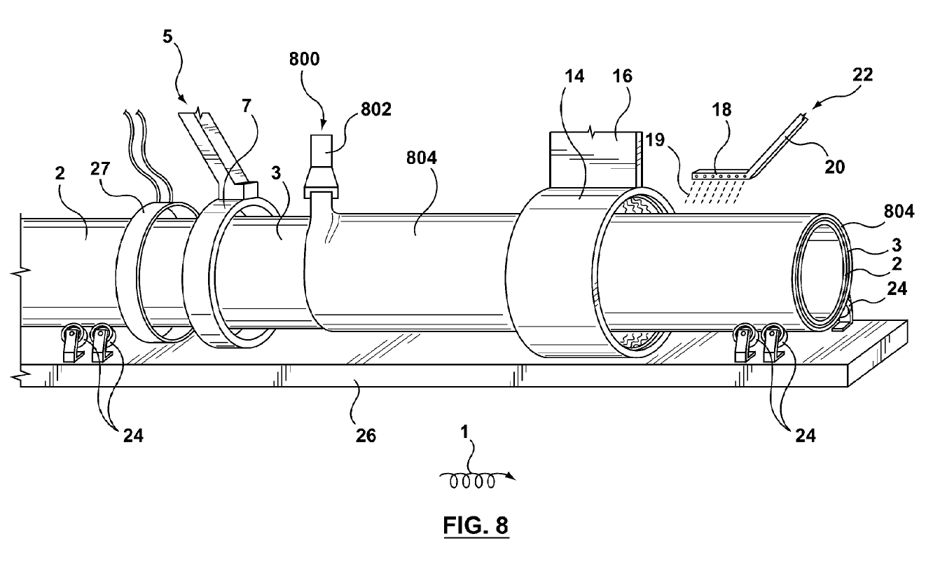

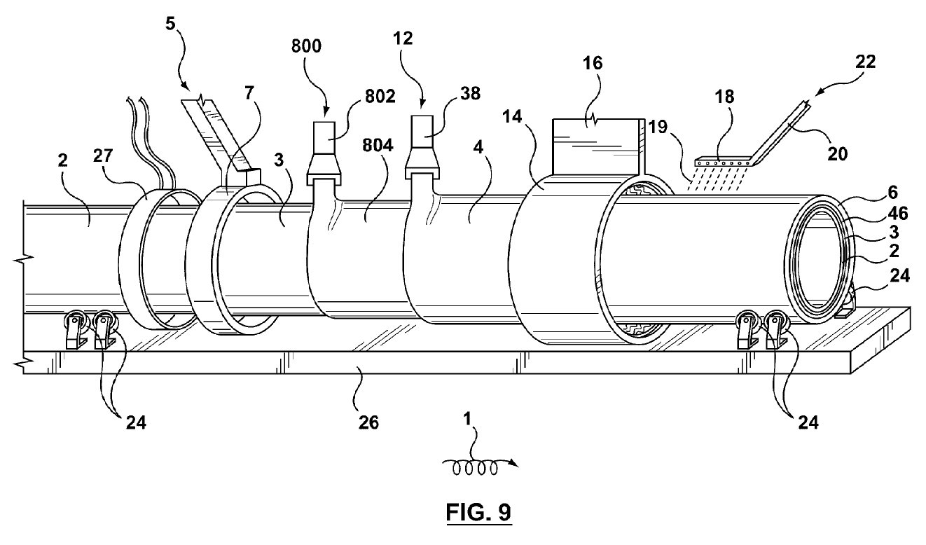

FIGS. 8 and 9 show schematics of apparatus for applying spray coated polyolefin. FIG. 8 shows an apparatus for applying a spray coated polyolefin layer over top of an FBE layer; FIG. 9 shows an apparatus which further applies an extruded, melted polyolefin layer above the spray coated reactive polyolefin blend layer. In FIG. 8, metal pipe 2 is conveyed in direction 1 along a conventional conveying assembly, comprising a conveyor frame 26 and conveying wheels 24. In this particular embodiment, the metal pipe is conveyed both longitudinally and rotationally, i.e. the pipe rotates as it moves forward along the conveying apparatus, though this is optional—instead, the apparatus could be configured with circular dies and/or spray coating device that rotate around the pipe, and the pipe would not rotate. Pipe 2 is conveyed through a pre-heater 27 which preheats the pipe to the required temperature. The pipe 2 is then conveyed through powder coater 7 which in turn is connected to a source of powdered fusion bonded epoxy 5. The powder coater 7 applies the powdered fusion bonded epoxy to the hot pipe 2 to form a fusion bonded epoxy coated pipe surface, or fusion bonded epoxy coating 3. The pipe 2 is then conveyed through a spray coater 802 which is fed with a powdered reactive polyolefin blend 800 as hereinbefore described. The spray coater gun 802 spray coats the hot pipe 2 to form a first polyolefin layer 804. The first polyolefin layer 804 may be a very thin layer, for example, 3-6 mils thick. The polyolefin blend 800 may be sprayed through the spray coater 802 directly onto the wet FBE coating 3, before the FBE coating 3 has gelled. This means that the FBE coating 3 gel time is not an issue, and there does not need to be a delay between the application of the FBE coating 3 and the first polyolefin layer 804. The first polyolefin layer 804 bonds very nicely to the FBE layer regardless of the time lag between applications. Pipe 2 is then (optionally) conveyed through an infra-red heater 14 mounted on infra-red heater frame 16 and surrounding the pipe 2. The infra red heater 14 (when used) applies infra-red energy for 5-25 seconds to the reactive polyolefin coating 4, partially or fully cross-linking it to form cross-linked polyolefin coating 6. The pipe 2 having a curing and/or optionally cross-linked polyolefin coating 6 (when infra red heater 14 is used) is then (optionally) conveyed through water dispensing system 18 which dispenses cool water 19 onto the pipe 2, rapidly cooling the cross-linked polyolefin coating 6. It would be appreciated that the speed of the conveying and of the rotating of the pipe 2, and the rate/speed of powdered reactive polyolefin blend powder 800 spray coated onto the pipe, will contribute to the thickness of reactive polyolefin coating 804. In addition, the speed of the conveying and the rotating of the pipe 2, the amount, wavelength, and proximity of the energy transmitted by infra-red heater 14, and the length of the infra-red heater 14 will all contribute to the amount of cross-linking in cross-linked polyolefin coating 6. It would also be appreciated that the speed of the conveying and the rotating of the pipe 2, and the rate at which FBE is sprayed onto the pipe by powder coater 7 will both contribute to the thickness of the fusion bonded epoxy coating 3. It would also be appreciated that the apparatus could have a different configuration, for example, having more than one spray coating gun 802, each with their own supply of reactive polyolefin powder 800, of identical or different composition. All these parameters can easily and readily be adjusted to obtain the desired pipe coating characteristics.

FIG. 9 shows an apparatus which further applies an extruded, melted polyolefin layer above the spray coated reactive polyolefin layer. In FIG. 9, metal pipe 2 is conveyed in direction 1 along a conventional conveying assembly, comprising a conveyor frame 26 and conveying wheels 24. In this particular embodiment, the metal pipe is conveyed both longitudinally and rotationally, i.e. the pipe rotates as it moves forward along the conveying apparatus, though this is optional—instead, the apparatus could be configured with circular dies and/or spray coating device that rotate around the pipe, and the pipe would not rotate. Pipe 2 is conveyed through a pre-heater 27 which preheats the pipe to the required temperature. The pipe 2 is then conveyed through powder coater 7 which in turn is connected to a source of powdered fusion bonded epoxy 5. The powder coater 7 applies the powdered fusion bonded epoxy to the hot pipe 2 to form a fusion bonded epoxy coated pipe surface, or fusion bonded epoxy coating 3. The pipe 2 is then conveyed through a spray coater 802 which is fed with a powdered reactive polyolefin blend 800 as hereinbefore described. The spray coater 802 spray coats the hot pipe 2 to form a first polyolefin layer 804. The first polyolefin layer 804 may be a very thin layer, for example, 3-6 mils thick. The polyolefin blend 800 may be sprayed through the spray coater 802 directly onto the FBE coating 3, even before the FBE coating 3 has gelled. This means that the FBE coating 3 gel time is not an issue, and there does not need to be a delay between the application of the FBE coating 3 and the first polyolefin layer 804. The first polyolefin layer 804 bonds very nicely to the FBE layer regardless of the time lag between applications. The pipe 2 is then conveyed through a flat extrusion die 38 through which a flow of melted reactive polyolefin 12 is extruded, onto the surface of the pipe 2. The melted, reactive polyolefin 12 bonds to the first polyolefin layer 804 as it is extruded, and forms a uniform, single layer polyolefin coating 4. As discussed in FIGS. 6 and 7, in alternative embodiments, there may be a plurality of flat extrusion dies (not shown) instead of the single flat extrusion die 38, in applications where it is desirable to have multiple extruded layers of polyolefin. Also as discussed in FIG. 7, where multiple flat extrusion dies are used, an in-line tape applying machine (not shown) may also be provided, for application of a reinforcing layer. In certain embodiments, where a plurality of dies are used, the melted, reactive polyolefin being extruded from each of the flat extrusion dies can be identical in composition, and accordingly forms a uniform, single layer of polyolefin on the pipe, with or without an imbedded reinforcing layer. In other embodiments, each of the flat extrusion dies may apply different compositions of polyolefin, to create a pipeline coating with varying properties through its thickness, and a reinforcing layer imbedded therein. In certain, preferred embodiments, and as described further below, for example in Example 9, the extruded polyolefin layer can be made “in situ” from locally sourced polyolefin (such as locally sourced PE) combined with a master batch formulation. Surprisingly, through the use of a thin sprayed first polyolefin layer, we have found excellent results with an extruded polyolefin layer that is as much as 94% locally-sourced polyolefin. This provides the advantages of a compact, highly “concentrated” master batch formulation, which can be made in a highly controlled environment, and stably shipped as a master batch formulation to local sites, where it can be extruded with up to 94% locally-sourced polyolefin powder or pellets. Like in previous embodiments, Pipe 2 is then (optionally) conveyed through an infra-red heater 14 mounted on infra-red heater frame 16 and surrounding the pipe 2. The infra-red heater 14 (when used) applies infra-red energy for 5-25 seconds to the reactive polyolefin coating 4, partially or fully cross-linking it to form cross-linked polyolefin coating 6. The pipe 2 having coating and/or cross-linked polyolefin coating 6 (as appropriate, depending on whether an infra-red heater 14 was used) is then optionally conveyed through water dispensing system 18 which dispenses cool water 19 onto the pipe 2, rapidly cooling the cross-linked polyolefin coating 6. It would be appreciated that the speed of the conveying and of the rotating of the pipe 2, the rate/speed of reactive polyolefin 12 extruded through the die 38, and the thickness of the opening in the dies 38, will contribute to the thickness of reactive polyolefin coating 4. In addition, the speed of the conveying and the rotating of the pipe 2, the amount, wavelength, and proximity of the energy transmitted by infra-red heater 14, and the length of the infra-red heater 14 will all contribute to the amount of cross-linking in cross-linked polyolefin coating 6. It would also be appreciated that the speed of the conveying and the rotating of the pipe 2, and the rate at which FBE is sprayed onto the pipe by powder coater 7 will both contribute to the thickness of the fusion bonded epoxy coating 3. It would additionally be appreciated that the speed and the rotating of the conveying of the pipe 2, and the rate at which powdered reactive polyolefin blend 800 is sprayed onto the pipe by spray coater 42, will contribute to the thickness of reactive coating 46. It would also be appreciated that the apparatus could have a different configuration, for example, having more than one extrusion die 38. In cases where it is desired that the polyolefin coming out of the plurality of extrusion dies are identical, it would be appreciated that the plurality of dies could be connected to the same extruder. Alternatively, each could be connected to its own extruder to allow for different polyolefin blends. The infra-red heaters could be a different source of energy, or entirely optional. All these parameters can easily and readily be adjusted to obtain the desired pipe coating characteristics.

### Single Coating Reactive Polyolefin/FBE Blend

As discussed above, the reactive polyolefin blends of the present invention can be prepared to a powder suitable for powder spray coating. These reactive polyolefin blend powders can be blended with FBE powder (also suitable for powder spray coating) and the blended reactive polyolefin/FBE powder can be applied to a pipe in a single coating layer.

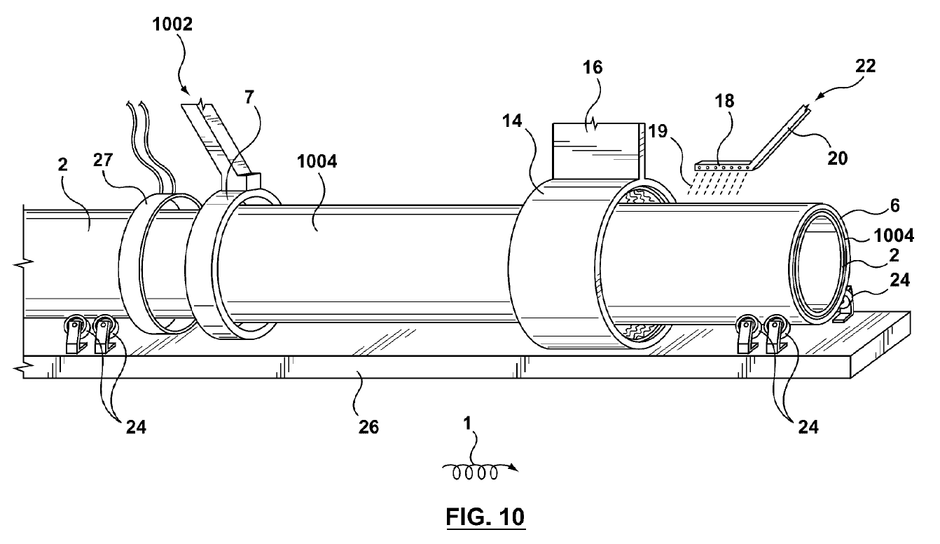

FIG. 10 shows an apparatus suitable for such spray coating. Metal pipe 2 is conveyed in direction 1 along a conventional conveying assembly, comprising a conveyor frame 26 and conveying wheels 24. In this particular embodiment, the metal pipe is conveyed both longitudinally and rotationally, i.e. the pipe rotates as it moves forward along the conveying apparatus, though this is optional—instead, the apparatus could be configured with circular dies and/or spray coating device that rotate around the pipe, and the pipe would not rotate. Pipe 2 is conveyed through a pre-heater 27 which preheats the pipe to the required temperature. The pipe 2 is then conveyed through powder coater 7 which in turn is connected to a source of powdered blend 1002 of fusion bonded epoxy and reactive polyolefin blend, for example, a reactive polyethylene or polypropylene blend as hereindescribed. The powder coater 7 applies the powdered blend 1002 to the hot pipe 2 to form a fusion bonded epoxy/polyolefin coated pipe surface, or fusion bonded epoxy/polyolefin coating 1004. Pipe 2 is then conveyed through an infra-red heater 14 mounted on infra-red heater frame 16 and surrounding the pipe 2. The infra red heater 14 applies infra-red energy for 5-25 seconds to the fusion bonded epoxy/polyolefin coating 4, partially or fully cross-linking it to form FBE/cross-linked polyolefin coating 6. The pipe 2 having FBE/cross-linked polyolefin coating 6 is then conveyed through water dispensing system 18 which dispenses cool water 19 onto the pipe 2, rapidly cooling the FBE/cross-linked polyolefin coating 6. It would be appreciated that the speed of the conveying and of the rotating of the pipe 2 will contribute to the thickness of FBE/reactive polyolefin coating 4. In addition, the speed of the conveying and the rotating of the pipe 2, the amount, wavelength, and proximity of the energy transmitted by infra-red heater 14, and the length of the infra-red heater 14 will all contribute to the amount of cross-linking in the fusion bonded epoxy/polyolefin coating 1004. The type of energy source used is also a factor, with other energy sources, rather than an infra-red heater 14, optional. It would also be appreciated that the speed of the conveying and the rotating of the pipe 2, and the rate at which powdered blend 1002 is sprayed onto the pipe by powder coater 7 will both contribute to the thickness of the fusion bonded epoxy/reactive polyolefin coating 4. All these parameters can easily and readily be adjusted to obtain the desired pipe coating characteristic

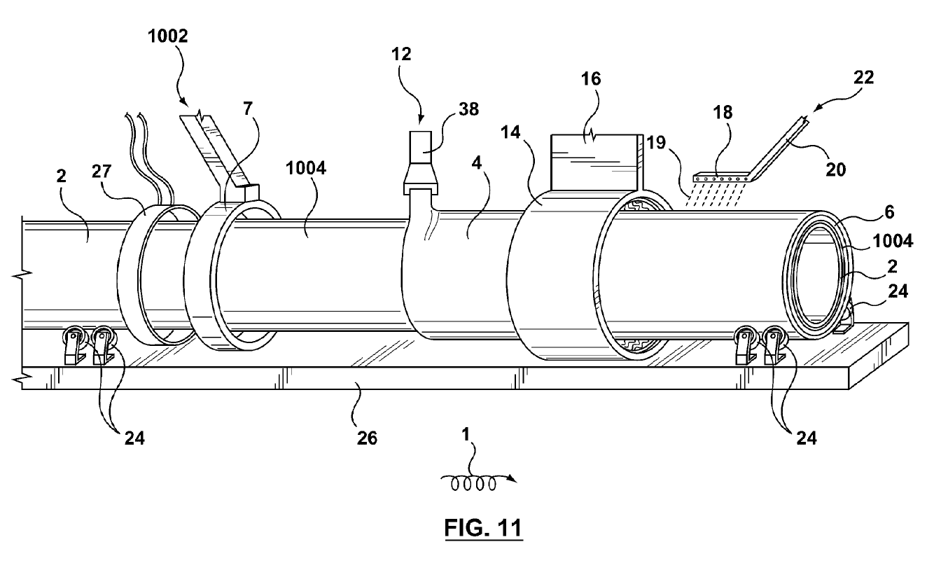

FIG. 11 shows an apparatus suitable for such spray coating, combined with an extrusion coating of reactive polyolefin overtop of the spray coating. Metal pipe 2 is conveyed in direction 1 along a conventional conveying assembly, comprising a conveyor frame 26 and conveying wheels 24. In this particular embodiment, the metal pipe is conveyed both longitudinally and rotationally, i.e. the pipe rotates as it moves forward along the conveying apparatus, though this is optional—instead, the apparatus could be configured with circular dies and/or spray coating device that rotate around the pipe, and the pipe would not rotate. Pipe 2 is conveyed through a pre-heater 27 which preheats the pipe to the required temperature. The pipe 2 is then conveyed through powder coater 7 which in turn is connected to a source of powdered blend 1002 of fusion bonded epoxy and reactive polyolefin blend, for example, a reactive polyethylene or reactive polypropylene blend as herein described. The powder coater 7 applies the powdered blend 1002 to the hot pipe 2 to form a fusion bonded epoxy/polyolefin coated pipe surface, or fusion bonded epoxy/polyolefin coating 1004. The pipe 2 is then conveyed through a flat extrusion die 38 through which a flow of melted, reactive polyolefin 12 is extruded, onto the surface of the pipe 2. In multiple thin layers the melted reactive polyolefin 12 bonds to the fusion bonded epoxy/reactive polyolefin layer 1004 as it is extruded, and forms a uniform, single layer polyolefin coating 4. As discussed in FIGS. 6 and 7, in alternative embodiments, there may be a plurality of flat extrusion dies (not shown) instead of the single flat extrusion die 38, in applications where it is desirable to have multiple extruded layers of reactive polyolefin. Also as discussed in FIG. 7, where multiple flat extrusion dies are used, an in-line tape applying machine (not shown) may also be provided, for application of a reinforcing layer. In certain embodiments, where a plurality of dies are used, the melted, reactive-polyolefin being extruded from each of the flat extrusion dies can be identical in composition, and accordingly forms a uniform, single layer of reactive polyolefin on the pipe, with or without an imbedded reinforcing layer. In other embodiments, each of the flat extrusion dies may apply different compositions of polyolefin, to create a pipeline coating with varying properties through its thickness, and a reinforcing layer imbedded therein. Like in previous embodiments, Pipe 2 is then conveyed through an infra-red heater 14 mounted on infra-red heater frame 16 and surrounding the pipe 2. The infra-red heater 14 applies infra-red energy for 5-25 seconds to the reactive polyolefin coating 4, partially or fully cross-linking it to form cross-linked polyolefin coating 6. The pipe 2 having cross-linked polyolefin coating 6 is then conveyed through water dispensing system 18 which dispenses cool water 19 onto the pipe 2, rapidly cooling the cross-linked polyolefin coating 6. It would be appreciated that the speed of the conveying and of the rotating of the pipe 2, the rate/speed of reactive polyolefin 12 extruded through the die 38, and the thickness of the opening in the dies 38, will contribute to the thickness of reactive polyolefin coating 4. In addition, the speed of the conveying and the rotating of the pipe 2, the amount, wavelength, and proximity of the energy transmitted by infra-red heater 14, and the length of the infra-red heater 14 will all contribute to the amount of cross-linking in cross-linked polyolefin coating 6. It would also be appreciated that the speed of the conveying and the rotating of the pipe 2, and the rate at which fusion bonded epoxy/polyolefin blend 1002 is sprayed onto the pipe by powder coater 7 will both contribute to the thickness of the reactive polyolefin coating 4. It would also be appreciated that the apparatus could have a different configuration, for example, having more than one extrusion die 38. In cases where it is desired that the polyolefin coming out of the plurality of extrusion dies are identical, it would be appreciated that the plurality of dies could be connected to the same extruder. Alternatively, each could be connected to its own extruder to allow for different polyolefin blends. All these parameters can easily and readily be adjusted to obtain the desired pipe coating characteristic. As discussed previously, utilizing the same or a similar polyolefin in the fusion bonded epoxy/reactive polyolefin blend 1002 and the reactive polyolefin blend 12 will result in a single layer coating, with a gradient of fusion bonded epoxy with a higher concentration of fusion bonded epoxy closer to the pipe surface.

### Example 1: Application of a Uniform Polyolefin Coating on a Pipe Utilizing Overlapping Wraps

An apparatus was manufactured configured as follows: The apparatus comprised a conveying assembly having a conveyor frame and wheels. The apparatus also comprised, in-line and in order, a sand blaster, a pre-heater, a powder coating machine, a spray coating machine, an extruder, an infra-red heater for cross-linking the reactive polyolefin, and a cooling station. The extruder was connected to one flat extrusion dies, and the speed of the conveyor, the size of the dies, and the output of the extruder were configured to extrude a 0.5 mm thick coating out of each die. The speed of the conveyor and the speed of rotation of the pipe was also configured so that the extrusion formed a ⅔ overlap, resulting in a three layer thick extrusion throughout the pipe length. The extruder hopper was loaded with pellets of polyolefin composition comprising polyethylene, and a metal pipe was loaded onto the conveyor. The powder coating machine was loaded with fine powder epoxy; the spray coating machine was loaded with reactive polyolefin suitable and compatible for adhering to both a FBE coating and a polyolefin coating. The metal pipe was conveyed both longitudinally and rotationally, through a sand-blaster for priming the pipe for coating, then a pre-heater which preheated the pipe to approximately 180-240° C., as appropriate and dependant on the type of FBE used. The pipe was then conveyed through the powder coater which coated the pipe with a thin coating of fusion bonded epoxy. The pipe was then conveyed through a spray coater which applied a reactive polyolefin coating to the fusion bonded epoxy. It is noted that the fusion bonded epoxy was still not completely set, and still gelling and reactive. The pipe was then conveyed through the flat extrusion die through which a flow of melted, reactive polyolefin was extruded to form a reactive polyolefin coating onto the reactive polyolefin coating. The conveying through the flat extrusion die was configured with a ⅔ overlap, resulting in 3 layers of reactive polyolefin being applied to each portion of the pipe by the single extrusion die. The pipe was then conveyed through an energy source such as an infra-red heater which applied infra-red energy for 5-25 seconds to the reactive polyolefin coating, partially or fully cross-linking it to convert it into a cross-linked polyolefin coating. The pipe was then conveyed through a cooling station in the form of a water dispensing system which dispensed cool water onto the coated pipe, rapidly cooling the cross-linked polyolefin coating 6.

This resulted in a three layer coating on the pipe—an FBE layer, closest to the steel of the pipe, a cross-linked polyolefin layer furthest from the steel of the pipe, and a reactive polyolefin layer binding the two. Though the cross-linked polyolefin layer was applied in three extrusions by the single die, since the layers were applied while the applied layers were still wet, they formed a single, uniform layer, with the thickness of three extrusion layers. In other words, because of the ⅔ overlap, and because the die dispersed enough polyolefin for a 0.5 mm thick layer of coating, the cross-linked polyolefin layer was approximately 1.5 mm thick. Because each of the applications of polyolefin occurred before the layer before it had time to completely cool, this resulted in what appeared to be a single, uniform, polyolefin layer approximately 1.5 mm thick.

### Example 2: Application of a Uniform Polyolefin Coating on a Pipe Utilizing Multiple Extrusions

An apparatus was manufactured configured as follows: The apparatus comprised a conveying assembly having a conveyor frame and wheels. The apparatus also comprised, in-line and in order, a sand blaster, a pre-heater, a powder coating machine, a spray coating machine, an extruder, an infra-red heater for cross-linking the polyolefin, and a cooling station. The extruders were connected to three flat extrusion dies, each in line and the speed of the conveyor, the size of the dies, and the output of the extruder were configured to extrude a 0.3 to 0.5 mm thick coating out of each die. The extruder hopper was loaded with pellets of polyolefin composition comprising polyethylene, and a metal pipe was loaded onto the conveyor. The powder coating machine was loaded with fine powder epoxy; the spray coating machine was loaded with reactive polyolefin suitable and compatible for adhering to both a FBE coating and a polyolefin coating. The metal pipe was conveyed both longitudinally and rotationally, through a sand-blaster for priming the pipe for coating, then a pre-heater which preheated the pipe to approximately 180-240° C., as appropriate and dependant on the type of FBE used. The pipe was then conveyed through the powder coater which coated the pipe with a thin coating of fusion bonded epoxy. The pipe was then conveyed through a spray coater which applied a reactive polyolefin coating, such as an adhesive coating, to the fusion bonded epoxy. It is noted that the fusion bonded epoxy was still not completely set, and still gelling and reactive. The pipe was then conveyed through the series of flat extrusion dies through which each a flow of melted, reactive polyolefin was extruded to form a coating onto the sprayed reactive polyolefin coating. The pipe was then conveyed through an energy source such as an infra-red heater which applied infra-red energy for 5-25 seconds to the reactive polyolefin coating, cross-linking it to convert it into a cross-linked polyolefin coating. The pipe was then conveyed through a cooling station in the form of a water dispensing system which dispensed cool water onto the coated pipe, rapidly cooling the cross-linked polyolefin coating 6.

This resulted in a three layer coating on the pipe—an FBE layer, closest to the steel of the pipe, a cross-linked polyolefin layer furthest from the steel of the pipe, and a reactive polyolefin layer binding the two. Because, the three extrusion dies were very close together, and each dispersed enough polyolefin for a 0.3-0.5 mm thick layer of coating, the cross-linked polyolefin layer was approximately 1.5 mm thick. Because each of the applications of polyolefin occurred before the layer before it had time to completely cool, this resulted in what appeared to be a single, uniform, cross-linked polyolefin layer approximately 1.5 mm thick. It can be appreciated that the use of three extrusion dies, very close together, each loaded with a different composition of reactive polyolefin, will result in a single reactive polyolefin layer with multiple layers within it, each of a different composition. It would be further appreciated that, since each extrusion die extruded reactive polyolefin, the single reactive polyolefin layer would have multiple layers within it, each forming a gradient at the interface. The degree and thickness of the gradient would depend on the setting time of the reactive polyolefin being applied, the speed of conveying and extrusion, and the heat of the reactive polyolefin being applied, among other factors.

### Example 3—Manufacturing of a Coated Pipe with an Integrated Reinforcing Layer

An apparatus was manufactured configured largely as in example 1, but with the following difference: instead of multiple dies, each fed from the same single extruder, each extruding 0.5 mm of reactive polyolefin composition, the apparatus was configured with two dies, each fed from a different extruder, each configured to extrude 0.5 mm of reactive polyolefin composition. The apparatus was configured such that, between these two dies was placed a tape application apparatus, as commercially available and known in the art. The tape application apparatus was loaded with a glass fiber mesh tape.

A pipe was run through the apparatus, largely as in Example 2, but having two extrusions dies instead of three, with an additional glass fiber mesh tape application there between. Essentially, the pipe passed through the first extrusion die, which applied a coating of reactive polyolefin. While the reactive polyolefin was still hot, the pipe was conveyed to the tape application apparatus, which wound the glass fiber mesh tape around the circumference of the pipe. The tape application apparatus was configured so that the tape, when applied, was slightly imbedded into the still soft reactive polyolefin coating. The pipe was then passed through the second extrusion die, which applied a coating of reactive polyolefin overtop of the tape. The tape can be a “dry” tape, having only strands of fiber; in the case of such a “dry” tape, the gap between strands is sufficiently large that the hot reactive polyolefin extruded from the first and second dies comingle and bond, through the tape. The tape may also be a “wet” tape, where the strands of fiber are pre-imbedded in a polyolefin; in this case, the polyolefin in the tape melts on application to the first reactive polyolefin layer, and bonds to both the reactive polyolefin layers extruded from the first and second dies. In both cases, the result is a single reactive polyolefin layer with an imbedded reinforcing fiber layer. As would be appreciated, it is desirable that the composition of the reactive polyolefin coming out of the first and second dies be compatible with one another, and compatible with the polyolefin in the wet tape when one is used; in preferable embodiments, the same polyolefin composition is utilized.

The remaining stations of the apparatus, and the remaining steps of the method, were identical to those of Example 2.

It would be appreciated that the same coated pipe with integrated reinforcing layer could be prepared using the apparatus of Example 1, by applying the tape between two layers of polyolefin extruded from the same extrusion die.

The result in either case was a three layer coating on the pipe—an FBE layer, closest to the steel of the pipe, a cross-linked polyolefin layer furthest from the steel of the pipe, and a reactive polyolefin layer binding the two. The cross-linked polyolefin layer contained, imbedded within it, a reinforcing layer comprising a fiberglass mesh. The cross-linked polyolefin layer was approximately 1.2 mm thick (due to the two 0.5 mm polyolefin coatings and approximately 0.2 mm attributed to the tape).

### Example 4: Coating a Pipe with a Sprayable Reactive Polyolefin Coating

An apparatus was manufactured configured as follows: The apparatus comprised a conveying assembly having a conveyor frame and wheels. The apparatus also comprised, in-line and in order, a sand blaster, a pre-heater, a first powder coating machine, a spray coating machine, a second powder coating machine, an extruder, an infra-red heater for partially or fully cross-linking the polyolefin, and a cooling station. The extruder was connected to a single flat extrusion die, and the speed of the conveyor, the size of the dies, and the output of the extruder were configured to extrude a 0.5 mm thick coating out of the die. The extruder hopper was loaded with pellets of polyolefin composition comprising polyethylene, and a metal pipe was loaded onto the conveyor. The first powder coating machine was loaded with fine powder epoxy; the spray coating machine was loaded with reactive polyolefin, for example, adhesive, suitable and compatible for adhering to both a FBE coating and a polyolefin coating. The second powder coating machine was loaded with fine powder reactive polyolefin composition. The metal pipe was conveyed both longitudinally and rotationally, through a sand-blaster for priming the pipe for coating, then a pre-heater which preheated the pipe to approximately 180-240° C. depending of the type of FBE. The pipe was then conveyed through the first powder coater which coated the pipe with a thin coating of fusion bonded epoxy. The pipe was then conveyed through a spray coater which applied a reactive polyolefin coating to the fusion bonded epoxy. It is noted that the fusion bonded epoxy was still not completely set, and still gelling and reactive. The pipe was then conveyed through the second powder coater, which coated the pipe with a first thin layer of reactive polyolefin. The pipe was then conveyed through the flat extrusion die, through which a flow of melted, reactive polyolefin was extruded to form a reactive polyolefin coating onto the first thin layer of reactive polyolefin. The pipe was then conveyed through an energy source such as an infra-red heater which applied infra-red energy for 5-25 seconds to the reactive polyolefin coating, partially or fully cross-linking it to convert it into a cross-linked polyolefin coating. The pipe was then conveyed through a cooling station in the form of a water dispensing system which dispensed cool water onto the coated pipe, rapidly cooling the cross-linked polyolefin coating 6.

Optionally, immediately after the application of the reactive polyolefin coating, the coating is cooled.

This resulted in a three layer coating on the pipe—an FBE layer, closest to the steel of the pipe, a cross-linked polyolefin layer furthest from the steel of the pipe, and a reactive polyolefin layer binding the two. Because the second powder coater and the extrusion die were very close together, and each dispersed enough polyolefin for a 0.5 mm thick layer of coating, the cross-linked polyolefin layer was approximately 1.0 mm thick. Because each of the applications of polyolefin occurred before the layer before it had time to completely cool, this resulted in what appeared to be a single, uniform, polyolefin layer approximately 1.0 mm thick.

### Example 5: Coating a Pipe with a Sprayable Reactive Polyolefin Coating

An apparatus was manufactured configured as follows: The apparatus comprised a conveying assembly having a conveyor frame and wheels. The apparatus also comprised, in-line and in order, a sand blaster, a pre-heater, a first powder coating machine, a second powder coating machine, an energy source such as an infra-red heater for cross-linking the reactive polyolefin, and a cooling station. The first powder coating machine was loaded with fine powder epoxy; the second powder coating machine was loaded with fine powder of reactive polyolefin composition. The metal pipe was conveyed both longitudinally and rotationally, through the sand-blaster for priming the pipe for coating, then the pre-heater which preheated the pipe to approximately 180-240° C. The pipe was then conveyed through the first powder coater which coated the pipe with a thin coating of fusion bonded epoxy. The pipe was then conveyed through the second powder coater, which coated the pipe with a first thin layer of reactive polyolefin. The pipe was then conveyed through an energy source such as an infra-red heater which applied infra-red energy for 5-25 seconds to the polyolefin coating, partially or fully cross-linking it to convert it into a cross-linked polyolefin coating. The pipe was then conveyed through a cooling station in the form of a water dispensing system which dispensed cool water onto the coated pipe, rapidly cooling the cross-linked polyolefin coating.

Optionally, the apparatus may also contain a cooling apparatus upstream of the IR heater, and a second heater upstream of that cooling apparatus. In certain embodiments, immediately after the application of the reactive polyolefin coating, the coating is cooled and/or heated to 190-240° C. to accelerate the curing process. This may occur before the cross-linking of the polyolefin coating with the IR energy.

This resulted in a two layer coating on the pipe—an FBE layer, closest to the steel of the pipe, and a cross-linked polyolefin layer furthest from the steel of the pipe. It was found that, surprisingly, and possibly because the second powder coating machine applied the reactive polyolefin coating to the FBE layer while the FBE layer was still gelling and not yet set, the FBE and a reactive polyolefin bonded together very well, without the need for an adhesive layer.

### Example 6: Single Coat FBE/Reactive PE Blend

An apparatus was manufactured configured as follows: The apparatus comprised a conveying assembly having a conveyor frame and wheels. The apparatus also comprised in-line and in order, a sand blaster, a pre-heater, a powder coating machine, an infra-red source for cross-linking the polyolefin, and a cooling station. The first powder coating machine was loaded with a blend of fine powder epoxy and a reactive polyolefin composition, at a weight ratio of 30:70 (epoxy: polyolefin). The blend was a generally homogeneous blend. The metal pipe was conveyed both longitudinally and rotationally, through the sand-blaster for priming the pipe for coating, then the pre-heater which preheated the pipe to approximately 180-240° C. The pipe was then conveyed through the powder coating machine which coated the pipe with a thin coating of the fusion bonded epoxy/reactive polyolefin. The pipe may or may not be conveyed through an energy source such as an infra-red heater which applied infra-red energy for 5-25 seconds to the fusion bonded epoxy/reactive polyolefin coating, cross-linking the polyolefin component to convert it into a epoxy/cross-linked polyolefin coating. The pipe was then conveyed through a cooling station in the form of a water dispensing system which dispensed cool water onto the coated pipe, rapidly cooling the cross-linked polyolefin coating.

Optionally, the apparatus may also contain a cooling apparatus upstream of the IR heater, and a second heater upstream of that cooling apparatus. In certain embodiments, immediately after the application of the reactive polyolefin coating, the coating is cooled and/or heated to 190-240° C. to accelerate the curing process. This may occur before the cross-linking of the polyolefin coating with the IR energy.

This resulted in a single layer coating on the pipe, conveying excellent corrosion—resistance and impact resistance properties, and excellent adherence to the pipe. It was surprisingly found that the single layer had a FBE/polyolefin gradient, with a higher concentration of FBE closer to the steel of the pipe, and a higher concentration of polyolefin at the exterior of the coating.

### Example 7: Single Coat FBE/Reactive PE Blend

An apparatus was manufactured configured as follows: The apparatus comprised a conveying assembly having a conveyor frame and wheels. The apparatus also comprised in-line and in order, a sand blaster, a pre-heater, a powder coating machine, an infra-red source for cross-linking the polyolefin, and a cooling station. The first powder coating machine was loaded with a blend of fine powder epoxy and a reactive polyolefin composition, at a weight ratio of 30:70 (epoxy: reactive polyolefin). The blend was a generally homogeneous blend. The metal pipe was conveyed both longitudinally and rotationally, through the sand-blaster for priming the pipe for coating, then the pre-heater which preheated the pipe to approximately 180-240° C. The pipe was then conveyed through the powder coating machine which coated the pipe with a thin coating of the fusion bonded epoxy/reactive polyolefin. The pipe was then conveyed through an energy source such as an infra-red heater which applied infra-red energy for 5-25 seconds to the fusion bonded epoxy/reactive polyolefin coating, partially or fully cross-linking the polyolefin component to convert it into a epoxy/cross-linked polyolefin coating. The pipe was then conveyed through a cooling station in the form of a water dispensing system which dispensed cool water onto the coated pipe, rapidly cooling the cross-linked polyolefin coating.

Optionally, the apparatus may also contain a cooling apparatus upstream of the IR heater, and a second heater upstream of that cooling apparatus. In certain embodiments, immediately after the application of the reactive polyolefin coating, the coating is cooled and/or heated to 190-240° C. to accelerate the curing process. This may occur before the cross-linking of the polyolefin coating with the IR energy.

This resulted in a single layer coating on the pipe, conveying excellent corrosion—resistance and impact resistance properties, and excellent adherence to the pipe. It was surprisingly found that the single layer had a FBE/polyolefin gradient, with a higher concentration of FBE closer to the steel of the pipe, and a higher concentration of polyolefin at the exterior of the coating.

### Example 8: Single Coat FBE/Reactive PE Blend (Option 2)

An apparatus was manufactured configured as follows: The apparatus comprised a conveying assembly having a conveyor frame and wheels. The apparatus also comprised in-line and in order, a sand blaster, a pre-heater, a powder coating machine, an extruder, an infra-red source for cross-linking the polyolefin, and a cooling station. The first powder coating machine was loaded with a blend of fine powder epoxy and a reactive polyolefin composition, at a weight ratio of 30:70 (epoxy:reactive polyolefin). The blend was a generally homogeneous blend. The extruder was connected to a single flat extrusion die, and the speed of the conveyor, the size of the dies, and the output of the extruder were configured to extrude a 0.5 mm thick coating out of the die. The extruder hopper was loaded with pellets of reactive polyolefin composition comprising reactive polyethylene, and a metal pipe was loaded onto the conveyor. The metal pipe was conveyed both longitudinally and rotationally, through the sand-blaster for priming the pipe for coating, then the pre-heater which preheated the pipe to approximately 180-240° C. The pipe was then conveyed through the powder coating machine which coated the pipe with a thin coating of the fusion bonded epoxy/reactive polyolefin. The pipe was then conveyed through the extruder portion through which a flow of melted, reactive polyolefin was extruded from a flat extrusion die to form a reactive polyolefin coating onto the fusion bonded epoxy/reactive polyolefin coating. The pipe was then conveyed through an energy source such as an infra-red heater which applied infra-red energy for 5-25 seconds to the fusion bonded epoxy/reactive polyolefin coating, partially or fully cross-linking the polyolefin component to convert it into a epoxy/cross-linked polyolefin coating. The pipe was then conveyed through a cooling station in the form of a water dispensing system which dispensed cool water onto the coated pipe, rapidly cooling the cross-linked polyolefin coating.

Optionally, the apparatus may also contain a cooling apparatus upstream of the IR heater, and a second heater upstream of that cooling apparatus. In certain embodiments, immediately after the application of the reactive polyolefin coating, the coating is cooled and/or heated to 190-240° C. to accelerate the curing process. This may occur before the cross-linking of the polyolefin coating with the IR energy.

This resulted in a single layer coating on the pipe, conveying excellent corrosion—resistance and impact resistance properties, and excellent adherence to the pipe. It was surprisingly found that the single layer had a FBE/reactive polyolefin gradient, with a higher concentration of FBE closer to the steel of the pipe, and essentially no FBE at the outer surface.

### Example 9: 3 Layer Coating Utilizing Master Batches

An apparatus was manufactured configured as follows: The apparatus comprised a conveying assembly having a conveyor frame and wheels. The apparatus also comprised in-line and in order, a sand blaster, a pre-heater, a first powder coating machine, a second powder coating machine, an extruder, (optionally) an infra-red source for cross-linking the polyolefin, and a cooling station. The first powder coating machine was loaded with FBE, and the speed of the conveyor, and the spray coating machine output was configured to provide an FBE coating of 150 to 250 microns. The second powder coating machine was loaded with reactive polyolefin blend, as shown in Table 1, below. The reactive polyolefin blend was made by compounding its components, for example, in a single or twin screw compounding machine, then grinded to a powder of a particle size suitable for powder coating. The second powder coating machine output was configured to provide a reactive polyolefin blend coating of 3-6 Mils.

TABLE 1
Reactive Polyolefin Blend

| Component | Wt % |
|---|---|
| Polyethylene | 93-94 |
| Black master batch 190858 | 0-0.80 |
| Antioxidant (for example Irganox | 0.20-0.5 |
| 1010 +/− Irgafos 168) | |
| Adhesive (maleic anhydride grafted | 3-4.00 |
| polyethylene (for example E265)) | |
| Wollastonite (for example Nyad | 0.5-1.00 |
| 400) | |
| Solid Epoxy (for example, DER | 0.5-1.00 |
| 6155 or other solid epoxy with | |
| equivalent weight of about 1200-1400) | |

The extruder was connected to a single flat extrusion die, and the speed of the conveyor, the size of the dies, and the output of the extruder were configured to extrude a 1.0-3.5 mm thick coating out of the die. The extruder hopper was loaded with pellets of an extrudable reactive polyolefin composition. The extrudable reactive polyolefin composition was made by combining a reactive polyolefin master batch with locally—sourced polyethylene and black master batch, in the wt. ratios shown in table 2, below. The locally—sourced polyethylene may have a melt index ranging from 0.2 to 2.2, and may be pipe grade, or optionally, rotational molding grade or even film grade. One of the advantages of this method is that the locally—sourced polyethylene can be what is expediently or otherwise advantageously available; for example, a blend of injection molding grade HDPE and film extrusion grade LLDPE may be used.

TABLE 2
Extrudable Reactive Polyolefin Composition

| Component | Wt % |
|---|---|
| Local polyethylene (melt index of 0.2-2.2) | 90-92 |
| 45% carbon black masterbatch | 4-5% |
| (Ampacet 190858) or equivalent | |
| Reactive polyolefin master batch | 3-5% |

The reactive polyolefin master batch was formulated as shown in Table 3, below.

TABLE 3
Reactive Polyolefin Master Batch

| Component | Wt % |
|---|---|
| Adhesive (maleic anhydride grafted | 50-62 |
| polyethylene (for example E265)) | |
| Polyethylene | 0-17.5 |
| Wollastonite (for example NYAD- | 10-20 |
| 400) | |
| Antioxidant (for example Irganox | 0.2-0.5 |
| 1010 +/− Irgafos 168) | |
| Solid Epoxy (for example, DER | 10-20 |
| 6155 or other solid epoxy with | |
| equivalent weight of about 1200-1400) | |

A metal pipe was loaded onto the conveyor. The metal pipe was conveyed both longitudinally and rotationally, through the sand-blaster for priming the pipe for coating, then the pre-heater which preheated the pipe to approximately 180-240° C. The pipe was then conveyed through the first powder coating machine which coated the pipe with a thin coating of the fusion bonded epoxy/reactive polyolefin. The pipe was then conveyed through the second powder coating machine which coated the pipe with a coating of the reactive polyolefin layer. Finally the pipe was conveyed through the extruder portion through which a flow of the melted, extrudable reactive polyolefin was extruded from a flat extrusion die to form a reactive polyolefin coating onto the fusion bonded epoxy/reactive polyolefin coating. The pipe was then optionally conveyed through an energy source such as an infra-red heater which applied infra-red energy for 5-25 seconds to the coating, partially or fully cross-linking the polyolefin component to convert it into a epoxy/cross-linked polyolefin coating. The pipe was then also conveyed through a cooling station in the form of a water dispensing system which dispensed cool water onto the coated pipe, rapidly cooling the cross-linked polyolefin coating.

Optionally, the apparatus may also contain a cooling apparatus upstream of the IR heater, and a second heater upstream of that cooling apparatus. In certain embodiments, immediately after the application of the reactive polyolefin coating, the coating is cooled and/or heated to 190-240° C. to accelerate the curing process. This may occur before the cross-linking of the polyolefin coating with the IR energy.

This resulted in a three layer coating on the pipe (FBE followed by two reactive polyolefin layers of different compositions). The coating provided excellent corrosion—resistance and impact resistance properties, and excellent adherence to the pipe.

1. A method for coating an elongate metallic tubular article having an exterior surface and an interior surface, comprising, in-line:
(a) heating the elongate metallic tubular article;
(b) powder coating the elongate metallic tubular article with a fusion bonded epoxy to form a fusion bonded epoxy coated article;
(c) before the fusion bonded epoxy has fully set, applying onto the fusion bonded epoxy coated article a reactive polyolefin composition to form a first reactive polyolefin coating, preferably by powder coating or extrusion;
(d) optionally applying a reinforcing mesh tape to the first reactive polyolefin coating, optionally before the first reactive polyolefin coating has set;
(e) optionally, before the first reactive polyolefin coating has set, extruding a second reactive polyolefin coating onto the first reactive polyolefin coating;
(f) optionally subjecting the resultant polyolefin coating to a source of energy, thereby partially or fully cross-linking said polyolefin coating, transforming said polyolefin coating into a cross-linked polyolefin coating; and
(g) rapidly cooling said cross-linked polyolefin coating.

2.-8. (canceled)

9. The method of claim 1 wherein the first reactive polyolefin coating comprises: polyolefin, preferably 93-94% polyethylene by weight; antioxidant, preferably 0.2-0.5% antioxidant by weight; adhesive, preferably 3-4% adhesive by weight; Wollastonite, preferably-0.5-1.0% Wollastonite by weight; solid epoxy, preferably 0.5-1.0% solid epoxy by weight; and optionally polyethylene.

10. (canceled)

11. The method of claim 1 wherein the second reactive polyolefin coating comprises: polyethylene, preferably 90-92% polyethylene by weight; a masterbatch formulation, preferably 3-5% of said masterbatch formulation, said masterbatch formulation comprising adhesive, preferably 50-62% adhesive by weight of the masterbatch formulation; wollastonite, preferably 10-20% Wollastonite by weight of the masterbatch formulation; antioxidant, preferably 0.2-0.5% antioxidant by weight of the masterbatch formulation; solid epoxy, preferably 10-20% solid epoxy by weight of the masterbatch formulation; and optionally polyethylene, preferably 0-17.5% polyethylene by weight of the masterbatch formulation; and optionally black masterbatch, preferably 4-5% masterbatch, by weight of the second reactive polyolefin coating.

12. (canceled)

13. The method of claim 9 wherein the adhesive is a maleic anhydride grafted polyethylene, preferably E265.

14. (canceled)

15. The method of claim 9 wherein the solid epoxy is DER 6155.

16. The method of claim 9 wherein the antioxidant is Irganox 1010+/− Irgafos 168.

17. A masterbatch composition comprising: adhesive, preferably 50-62% adhesive by weight; wollastonite, preferably 10-20% Wollastonite by weight; antioxidant, preferably 0.2-0.5% antioxidant by weight; solid epoxy, preferably 10-20% solid epoxy by weight; and optionally polyethylene.

18. (canceled)

19. The masterbatch composition of claim 17 wherein the adhesive is a maleic anhydride grafted polyethylene, preferably E265.

20. (canceled)

21. The masterbatch composition of claim 18 wherein the solid epoxy is DER 6155.

22. The masterbatch of claim 18 wherein the antioxidant is Irganox 1010+/− Irgafos 168.

23. A reactive polyolefin composition comprising: the masterbatch composition of claim 17, preferably 3-5% the masterbatch composition of claim 17 by weight; polyethylene, preferably 90-92% polyethylene by weight; and optionally black masterbatch, preferably 4-5% black masterbatch by weight.

24. (canceled)

25. A reactive polyolefin composition comprising: polyethylene, preferably 93-94% polyethylene by weight; antioxidant, preferably 0.2-0.5% antioxidant by weight adhesive, preferably 3-4% adhesive by weight; Wollastonite, preferably 0.5-1% Wollastonite by weight; optionally solid epoxy, preferably 0.5-1% solid epoxy by weight; and optionally black master batch.

26. (canceled)

27. The reactive polyolefin composition of claim 25 wherein the adhesive is a maleic anhydride grafted polyethylene, preferably E265.

28. (canceled)

29. The reactive polyolefin composition of claim 25, wherein the solid epoxy is DER 6155.

30. The reactive polyolefin composition of claim 25, wherein the antioxidant is Irganox 1010+/−Irgafos 168.

31. A method for coating an elongate metallic tubular article having an exterior surface and an interior surface, comprising, in-line:
(a) applying a reactive polyolefin composition to said exterior surface to form a reactive polyolefin coating thereon, preferably comprising an extrusion onto said exterior surface of a hot, melted, reactive polyolefin composition, and/or powder coating said exterior surface with said reactive polyolefin composition;
(b) applying a reinforcing mesh tape to the reactive polyolefin coating formed in step (a);
(c) applying a second layer of reactive polyolefin composition to said reinforcing mesh tape to form a reinforced polyolefin coating;
(d) subjecting the reinforced polyolefin coating to a source of energy, thereby partially or fully cross-linking said reinforced polyolefin coating, transforming said reinforced polyolefin coating into a cross-linked reinforced polyolefin coating; and
(e) rapidly cooling said cross-linked reinforced polyolefin coating.

32.-37. (canceled)

38. A method for coating an elongate metallic tubular article having an exterior surface and an interior surface, comprising, in-line:
(a) heating the elongate metallic tubular article;
(b) powder coating the elongate metallic tubular article with a blend of a fusion bonded epoxy and a reactive polyolefin composition to form a fusion bonded epoxy/reactive polyolefin coating;
(c) optionally extruding or powder coating the fusion bonded epoxy/reactive polyolefin coating with reactive polyolefin to form a reactive polyolefin coating;
(d) optionally subjecting the fusion bonded epoxy/reactive polyolefin coating to a source of energy, thereby partially or fully cross-linking said polyolefin coating, transforming said polyolefin coating into a cross-linked polyolefin coating; and
(e) rapidly cooling said cross-linked polyolefin coating.

39. (canceled)

40. The method of claim 38 wherein the blend of fusion bonded epoxy and reactive polyolefin composition is a 30:70 weight ratio of fusion bonded epoxy to reactive polyolefin composition.

41. The method of claim 38 wherein the blend of fusion bonded epoxy and reactive polyolefin composition is a homogeneous blend.

42. An apparatus for coating a moving elongate metallic tubular article, comprising:
(a) a heating station;
(b) a powder coating station;
(c) an extruding station preferably comprising an extrusion die, such as a flat extrusion die or a circular extrusion die;
(d) optionally an energy source station, preferably comprising a source of infra-red energy, a source of ultra-violet energy, an electron beam, a source of micro wave energy, an induction coil, a source of hot air, and/or a convection oven;
(e) a cooling device station; and
(f) a conveying assembly for moving the elongate metallic tubular article between stations.

43.-44. (canceled)

45. A composition comprising fusion bonded epoxy powder and a reactive polyolefin powder, preferably in a weight ratio of about 1-99, more preferably about 30:70; preferably having a mean particle size of 300 microns or less; and preferably in a homogeneous blend.

46.-48. (canceled)
